(19) United States
(12) Patent Application Publication
(10) Pub. No.: US 2012/0225698 A1
(43) Pub. Date: Sep. 6, 2012

(54) MOBILE COMMUNICATION TERMINAL, INPUT CONTROL PROGRAM AND INPUT CONTROL METHOD

(75) Inventors: Kazuto Miyazaki, Daito-shi (JP); Takashi Izumi, Daito-shi (JP)

(73) Assignee: KYOCERA Corporation, Kyoto (JP)

(21) Appl. No.: 13/509,354

(22) PCT Filed: Nov. 9, 2010
(86) PCT No.: PCT/JP2010/006565

§ 371 Date: May 11, 2012

(30) Foreign Application Priority Data
Nov. 12, 2009 (JP) 2009-259359

(51) Int. Cl. H04W 88/02

(52) U.S. Cl. 455/566

(57) ABSTRACT

A portable communication terminal pertaining to the present invention comprises a touchpad that detects contact made thereto and outputs a value indicating a degree of the contact, and select, based on the value output by the touchpad, one area from among areas on the touchpad on which contact is detected, the areas each having processing to be executed allocated thereto. When the communication terminal does not judge that the number of areas on which contact is detected equals or exceeds a predetermined number within a time period from the selection until a specific condition is satisfied, the communication terminal does not execute the processing allocated to the selected area. The specific condition includes a requirement that contact made to the selected area continues to be detected for a predetermined time period from the selection. When the communication terminal judges in the affirmative, the communication terminal does not execute the processing.

### TECHNICAL FIELD

The present invention relates to a portable communication terminal such as a mobile phone having a touchpad.

### BACKGROUND ART

According to portable communication terminals such as mobile phones which can be operated by using a touchpad, based on a value indicating a degree of contact made to the touchpad (value indicating an electrostatic capacitance, for example), a contact area on the touchpad to which the contact has been made is detected, and processing allocated to the contacted area is performed.

Accordingly, processing that the user does not intend might be performed (referred to hereinafter as an “erroneous operation”) in the case where, for example, a portable communication terminal is put in the user's bag and an object which is put in the bag along with the portable communication terminal contacts the touchpad of the portable communication terminal (referred to hereinafter as “erroneous contact”).

In response to this problem, Patent Literature 1 discloses a control method, for example. According to this control method, it is judged as to whether the size of a contact area on a touchpad to which contact has been made exceeds a predetermined size. When the size of the contacted area exceeds the predetermined size, control is performed such that processing based on this contact is not performed.

Accordingly, as the predetermined size, a boundary value of area size is determined, which is the boundary between a range in the case of contact made by the user's finger or the like and a range in the case of contact made by objects other than the finger or the like. As a result, in the case where contact is made to the touchpad by an object other than the finger or the like, it is possible to reduce the possibility of the occurrence of erroneous operations.

As a function of a portable communication terminal such as a mobile phone, it is known that specific processing is performed by pressing a key used for operations for longer than a predetermined time period (hereinafter referred to as a “long press”). As one example of such specific processing, there has been known a function for automatically making a call to a telephone number that has been associated beforehand with the key (this function is hereinafter also referred to as a “speed dial”).

Usually, when making a call, a user needs to select a communication party in the address book or the call register or perform an off-hook operation after inputting a telephone number. However, speed dial enables the user to make a call to a predetermined communication party with a simple operation of pressing a key for longer than a predetermined time period.

Here, Patent Literature 2 discloses another control method for appropriately processing key input such as pressing of a plurality of keys (hereinafter referred to as “plural key press”) or long press. According to the control method disclosed in Patent Literature 2, long press and plural key press are detected and it is further judged whether plural key press is valid. If plural key press is valid, the press is treated as long press of one of the plurality of keys that is to be prioritized to be input.

### CITATION LIST

### Patent Literature

[Patent Literature 1]
   Japanese Patent Application Publication No. 2004-126752
[Patent Literature 2]
   Japanese Patent Application Publication No. 2001-134365

### SUMMARY OF INVENTION

### Technical Problem

When incorporating a specific function performed in response to long press into a portable communication terminal which can be operated by using a touchpad, long press might be detected on a key of the touchpad and an unintended function might be processed due to the erroneous contact described above. For example, in the case of speed dial described above, long press might be detected on a key of the touchpad and a call might be made to an unintended person, due to the erroneous contact described above.

The present invention has been achieved in view of the above problem, and aims to provide a portable communication terminal such as a mobile phone that can reduce the possibility that specific processing is performed when long press is detected on the touchpad due to the erroneous contact.

### Solution to Problem

In order to solve the above problems, a portable communication terminal pertaining to the present invention is a portable communication terminal comprising: a touchpad configured to detect contact made thereto and output a value indicating a degree of the contact; a selecting unit configured to select, based on the value output by the touchpad, one area from among areas on the touchpad on which contact is detected, the areas each having processing to be executed allocated thereto; a first judgment unit configured to judge whether or not the number of areas on the touchpad on which contact is detected equals or exceeds a predetermined number within a time period from the selection until a specific condition is satisfied, the specific condition including a requirement that contact made to the selected area continues to be detected for a predetermined time period from the selection; and an execution control unit configured, when the first judgment unit judges in the negative, to execute processing allocated to the selected area, and when the first judgment unit judges in the affirmative, not to execute the processing.

Here, the term “contact” not only refers to a state where a user's finger, face, or other body parts, or objects such as a touch pen is put into direct contact with the touchpad. Especially when the touchpad is a capacitive touchpad, the term “contact” also refers to a state where a user's finger, face, or other body parts, or objects such as a touch pen comes in close proximity to the touchpad and thus, changes the electrostatic capacity of the touchpad by a greater degree than a predetermined level of change.

### Advantageous Effects of the Invention

A portable communication terminal pertaining to the present invention with the above structure can reduce the possibility that specific processing is performed when long press is detected on the touchpad due to the erroneous contact.

### BRIEF DESCRIPTION OF DRAWINGS

FIG. 1 is a perspective view illustrating the exterior appearance of a mobile phone 100 pertaining to embodiment 1 is a closed state.

FIG. 2 is a perspective view illustrating the exterior appearance of the mobile phone 100 pertaining to embodiment 1 during an open state thereof.

FIG. 3 is a front elevational view illustrating the exterior appearance of the mobile phone 100 pertaining to embodiment 1 during a closed state thereof.

FIG. 4 is a block diagram illustrating the functional structure of the main units of the mobile phone 100.

FIG. 5 shows an example of the data structure and contents of an address book 10 stored in the mobile phone 100.

FIG. 6 illustrates the change observed in a key contact value calculated by a calculation unit 111.

FIG. 7 is a flowchart illustrating control processing performed by the mobile phone 100 in response to input from a touchpad 102.

FIG. 8 is a flowchart illustrating key allocated processing of a target key (step S20 in FIG. 7) performed by the mobile phone 100.

FIGS. 9A-9D illustrate examples of operation of the mobile phone 100 in response to contact of the touchpad 102.

FIG. 10 is a flowchart illustrating key allocated processing of a target key performed by a first modified mobile phone.

FIG. 11 is a flowchart illustrating key allocated processing of a target key performed by a second modified mobile phone.

FIG. 12 is a flowchart illustrating control processing performed by a third modified mobile phone in response to input from the touchpad 102.

FIG. 13 is a flowchart illustrating key allocated processing of a target key (step S80 in FIG. 12) performed by the third modified mobile phone.

### DESCRIPTION OF EMBODIMENT

In the following, description is made on a mobile phone as one embodiment of the portable communication terminal pertaining to the present invention.

### Embodiment 1

### Exterior Appearance

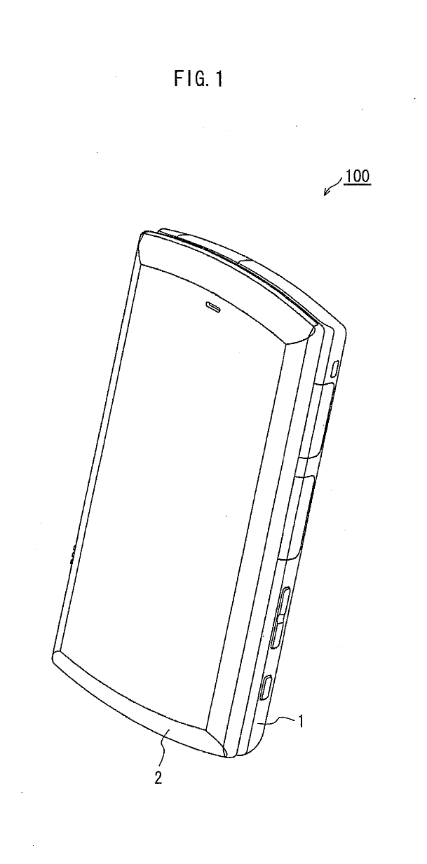

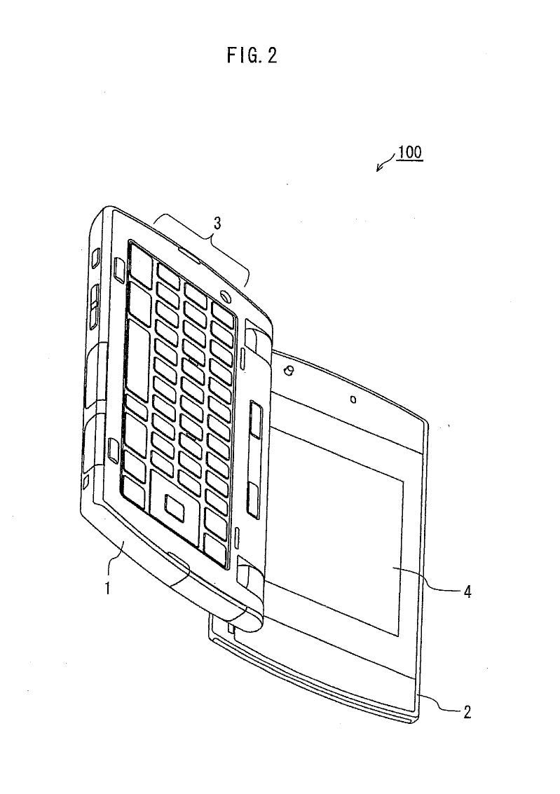

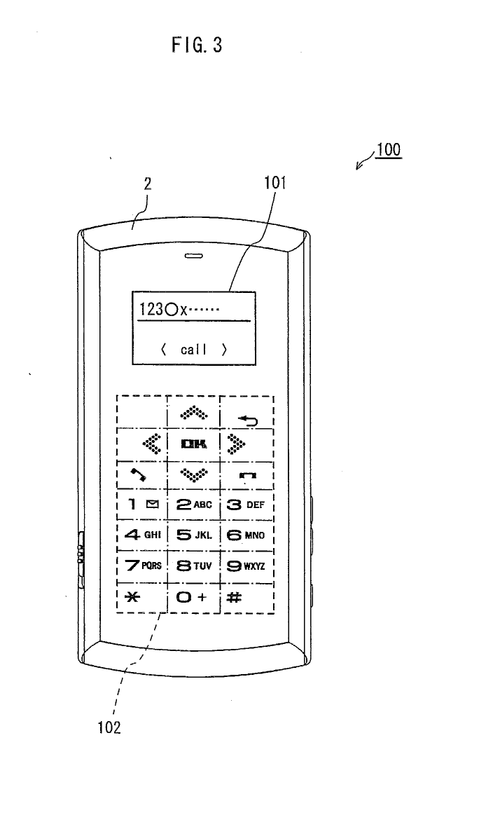

FIG. 1 is a perspective view illustrating the exterior appearance of a mobile phone 100 pertaining to embodiment 1 during a closed state thereof. FIG. 2 is a perspective view illustrating the exterior appearance of the mobile phone 100 pertaining to embodiment 1 during an open state thereof. FIG. 3 is a front elevational view illustrating the exterior appearance of the mobile phone 100 pertaining to embodiment 1 during a closed state thereof.

As illustrated in FIGS. 1 and 2, the mobile phone 100 is a flip-type mobile phone which opens vertically with respect to a longitudinal direction thereof. The mobile phone 100 is composed of a housing 1 and a housing 2 which are joined in a mutually openable state. The housing 1 is provided with input keys 3, and the housing 2 is provided with an LCD (Liquid Crystal Display) 4 which is used as a screen for displaying information.

Although not depicted in FIG. 1, the mobile phone 100 includes a sub LCD 101 and a touchpad 102, both of which are disposed on an external surface of the housing 2 which is exposed to the outside when the mobile phone 100 is in a closed state thereof. Illustrations of the sub LCD 101 and the touchpad 102 are found in FIG. 3.

The touchpad 102 has provided thereon marks which represent respective various keys of the mobile phone 100. These marks representing the various keys are made visible to a user. The user causes the mobile phone 100 to perform processing allocated to a certain key by putting his/her finger or the like in contact with a location on the touchpad 102 having the mark representing the certain key.

In FIG. 3, the touchpad 102 is illustrated as being divided into multiple areas by dashed-dotted lines. Each of the areas indicates an area (approximately 5 mm×10 mm, for example) corresponding to one of the keys. Note that the dashed-dotted lines are illustrated for the mere sake of explanation, and are not visible to the user. Further, the key indicated by the mark “1” is referred to, for example, as the “1 key” hereinafter, and the same applies to the keys represented by the rest of the marks illustrated in FIG. 3.

In addition, it is to be noted that the types of keys which are provided to the touchpad 102 and the order in which the keys are arranged in the illustration of FIG. 3 are mere examples, and are to be altered as necessary.

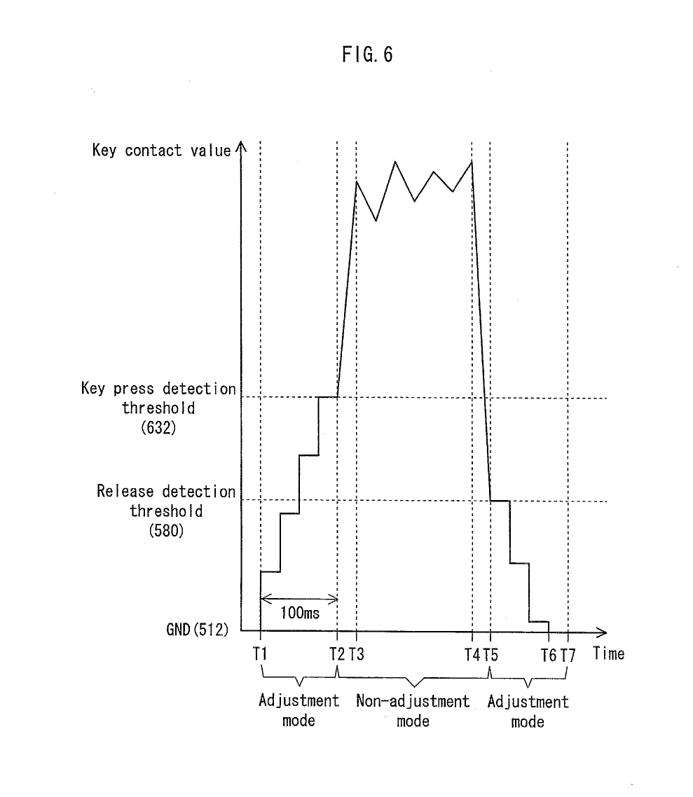

Additionally, in the present embodiment, the term “contact” not only refers to a state where a user's finger, face, or other body parts, or objects such as a touch pen is put into direct contact with the touchpad. The term “contact” also refers to a state where a user's finger, face, or other body parts, or objects such as a touch pen, all of which being capable of changing the electrostatic capacity of the touchpad 102, comes in close proximity to the touchpad and thus, causes a later-described key contact value (refer to FIG. 6) to equal or exceed a GND level.

Further, in the following explanation, the term “press” is also used to indicate a state where the user contacts the touchpad 102 with the use of his/her finger or the like, and thereby selects a key on the touchpad 102.

Furthermore, in the following explanation, the mobile phone 100 performs different processing between the case where each of the number keys 0 through 9 is pressed for a short time period (hereinafter, referred to as “short press”) and the case of long press where each number key is pressed for longer than a predetermined time period. Especially when long press of a number key is detected and the number key has been allocated the telephone number beforehand by the user, a call is made to the allocated telephone number. Allocation of telephone numbers to the number keys is described later.

<Structure>

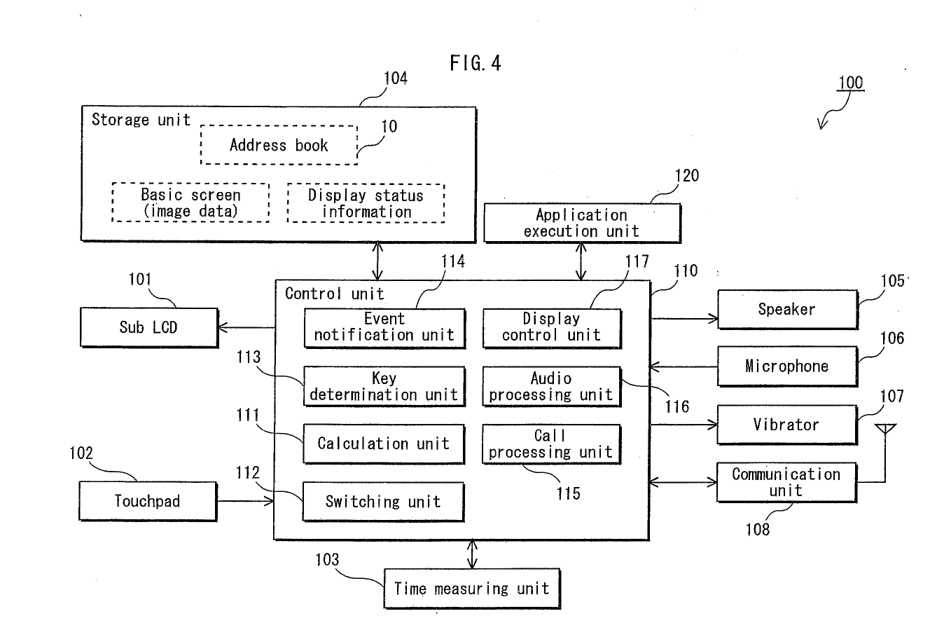

FIG. 4 is a block diagram illustrating the functional structure of main units of the mobile phone 100.

As illustrated in FIG. 4, the mobile phone 100 includes a sub LCD 101, the touchpad 102, a time measuring unit 103, a storage unit 104, a speaker 105, a microphone 106, a vibrator 107, a communication unit 108, a control unit 110, and an application execution unit 120.

The mobile phone 100 includes a processor and a memory in the structure thereof. The functions of the control unit 110 and the application execution unit 120 are realized by the processor executing a program stored onto the memory. Note that, hereinafter, it is presumed that various threshold values, which are to be later described, are stored onto the memory.

The sub LCD 101 displays images such as characters by receiving instructions from the control unit 110.

The touchpad 102 is embodied by a conventional capacitive touch sensor. The touchpad 102 is a circuit for detecting contact made thereto by the user and for transmitting at least one pair of values to the control unit 110 while the contact is being detected. Each of the at least one pair of values consists of a coordinate value (x, y) indicating a position on the touchpad to which contact is made, and a value indicating the electrostatic capacity of the contacted position. More specifically, the touchpad 102, while contact is being detected, transmits the at least one pair of values to the control unit 110 every time a unit interval (25 ms, for example) elapses, and when contact is being made to multiple positions on the touchpad 102, the touchpad 102 transmits a plurality of pairs of values to the control unit 110.

In FIG. 3, the touchpad 102 is illustrated as a rectangular area surrounded by broken lines. As for examples of coordinate values of positions on the touchpad 102, the top left vertex of the rectangle representing the touchpad 102 is denoted by a coordinate value (0, 0), whereas the bottom right vertex of the rectangle representing the touchpad 102 is denoted by a coordinate value (160, 220).

The time measuring unit 103 is embodied as a timer or a counter, and according to instructions provided from the control unit 110, performs the measurement of time. In detail, the time measuring unit 103 commences the measurement of time by receiving an instruction from the control unit 110, and transmits a notification to the control unit 110 when a long-press time duration (800 ms, for example) elapses.

The long-press time duration is a threshold value used for judging whether contact made to a key is long press. The long-press time duration has been set in advance by the manufacturer of the mobile phone 100, for example.

The storage unit 104 is a memory region for storing a basic screen, display status information, and the address book 10.

The basic screen is, for example, data of an image displayed on the sub LCD 101 during making a call, during a call, or the like.

Also, the display status information is information indicating the status of a screen displayed on the sub LCD 101, and is configured such that it is possible to identify how the displayed screen has been generated.

For example, the display status information of a screen displayed on the sub LCD 101 shown in FIG. 3 indicates that the standby screen (in this example, the state where nothing is displayed) has switched to the state where “123∘x . . . ” and “<call>” are displayed on the sub LCD 101.

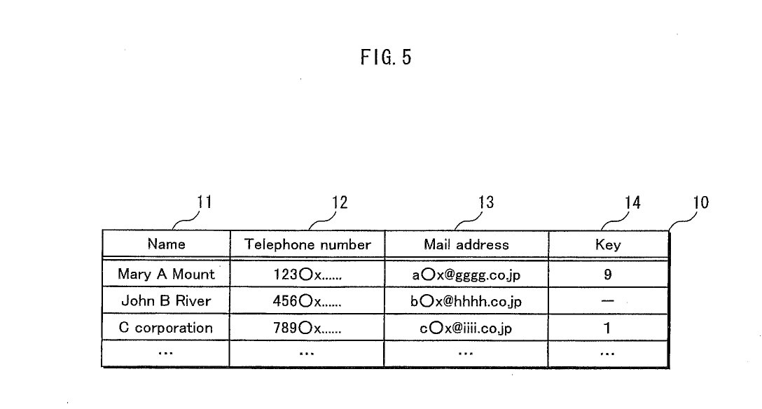

The following describes the address book 10 with reference to FIG. 5.

FIG. 5 shows an example of the data structure and contents of the address book 10.

As shown in FIG. 5, the address book 10 is data in which a name 11, a telephone number 12, a mail address 13, and a key 14 are associated with one another for each piece of contact information of communication parties.

The name 11 is data indicating a name such as a full name indicating a communication party of a call or a mail. The telephone number 12 is data indicating a telephone number allocated to telephone equipment owned by the communication party. The mail address 13 is data indicating a mail address owned by the communication party. The key 14 is data indicating a number key of the touchpad 102 to which a telephone number associated therewith has been allocated.

Note that a sign “−” indicates that there is no number key to which a telephone number associated therewith has been allocated.

FIG. 5 shows that, for example, a communication party whose name is “Mary A Mount” owns the telephone number “123∘x . . . ” and the mail address “a∘x@gggg.co.jp”, and has been allocated to the key “9”, which means that the telephone number “123 ∘x . . . ” has been allocated to the 9 key.

Note that the registration of a key in the address book 10 is performed by the user. In detail, when the user newly registers contact information or when the user changes contact information that has been already registered, the user specifies a key to which no telephone number of another communication party has been registered.

The communication unit 108 is a circuit for performing transmission/reception of radio waves with a base station via an antenna. More specifically, the communication unit 108 is provided with the functions of: receiving signals transmitted from the base station; demodulating the received signals; and transmitting the demodulated signals to the control unit 110, as well as the functions of: receiving signals transmitted from the control unit 110; modulating the received signals; and transmitting the modulated signals to the base station.

The control unit 110 has, in addition to the functions provided to a conventional mobile phone, the functions of an OS (operating system). That is, the control unit 110 receives the at least one pair of values from the touchpad 102, and, based on the at least one pair of values received, notifies the application execution unit 120 of an event. As already described in the above, each of the at least one pair of values consists of a coordinate value of the contacted position and an electrostatic value of the contacted position. Further, the event includes information of a key of the touchpad 102 being pressed. The control unit 110 includes: a calculation unit 111; a switching unit 112; a key determination unit 113; an event notification unit 114; a call processing unit 115, an audio processing unit 116; and a display control unit 117.

The calculation unit 111 performs the management of positions (coordinate areas) of the keys on the touchpad 102. In addition, the calculation unit 111 calculates a value (referred to hereinafter as a “key contact value”) which increases/decreases within a range between 0 and 1024, for each of the keys contacted. The calculation is based on the at least one pair of values transmitted by the touchpad 102, each of which consisting of a coordinate value (x, y) indicating a contacted position and the electrostatic capacity value of the contacted position.

Furthermore, the calculation unit 111 switches between two modes according to instructions provided by the switching unit 112, one of the modes being a non-adjustment mode and the other being an adjustment mode. As already mentioned above, the calculation unit 111 calculates, for each of the contacted keys, a value which increases/decreases between 0 and 1024 according to the increase/decrease of contact area within a coordinate area corresponding to the contacted key. Following this, in the non-adjustment mode, the calculation unit 111 sets the calculated value as the key contact value without performing any adjustment. On the other hand, in the adjustment mode, the calculation unit 111 sets, as the key contact value, a value obtained by performing adjustment on the calculated value. More specifically, the calculation unit in the adjustment mode performs the adjustment such that an amount of change, or a difference, between a key contact value of a contacted key and a previous key contact value of the same contacted key which has been determined a unit interval ago (25 ms, in this example) is smaller than or equal to a predetermined value (“30”, in the following description). The same calculation and adjustment is performed for each of the contacted keys.

Thus, in the adjustment mode, when the difference between the calculated value of a contacted key and the previous key contact value of the same contacted key which has been determined a unit interval ago is smaller than or equal to the predetermined value, the calculated value is set as the key contact value. On the other hand, when the difference between the calculated value of the contacted key and the previous key contact value of the same contacted key is greater than the predetermined value, the key contact value is determined as a value obtained by adding the predetermined value to the previous key contact value.

As the calculated value of a contacted key, or that is, the value which increases/decreases between 0 and 1024 according to the increase/decrease of contact area within a coordinate area corresponding to the contacted key, a value obtained by performing scale conversion on a sum total of the electrostatic capacity values within the coordinate area of the contacted key such that the converted value is between 0 and 1024 may be used, for example.

Detailed description on how a key contact value of a contacted key changes according to the switching between the two modes of the calculation unit 111 is provided in the following (refer to FIG. 6).

The switching unit 112 causes the calculation unit 111 to switch between the two modes thereof according to the current mode of the calculation unit 111 (non-adjustment mode or adjustment mode) and the key contact values calculated by the calculation unit 111.

In detail, the switching unit 112 causes the calculation unit 111 to switch from the adjustment mode to the non-adjustment mode when a key contact value calculated by the calculation unit 111 exceeds a key press detection threshold. In contrast, the switching unit 112 causes the calculation unit 111 to switch from the non-adjustment mode to the adjustment mode when all of the key contact values calculated by the calculation unit 111 fall below a release detection threshold.

Here, the key press detection threshold is a threshold used for judging whether a key has been pressed, and a value thereof is, for example, “632”. The release detection threshold is a threshold used for judging whether a key has been released, and a value thereof is, for example, “580”.

Detailed explanation is provided later on the timing at which the switching unit 112 causes the calculation unit 111 to switch between the two modes thereof (refer to FIG. 6).

The key determination unit 113 determines one key (referred to hereinafter as a “target key”) according to the key contact values calculated by the calculation unit 111. As mentioned in the following, the mobile phone 100 executes processing allocated to the target key.

The key determination unit 113 generally determines, as the target key, a key having the greatest key contact value among the keys having key contact values equal to or greater than the key press detection threshold (632). However, exceptional cases exist, where the target key is not determined in such a manner. Such cases include (i) a case (referred to hereinafter as “multiple key press”) where the number of keys having key contact values equal to or greater than a multiple key press detection threshold (“580”, for example) exceeds a predetermined number of keys, and (ii) a case where there exists, between a combination of two of the keys having key contact values equal to or greater than a multiple key press detection threshold, a key having a key contact value smaller than or equal to the release detection threshold (580).

Such cases are exceptional, since, in such cases, it can be assumed that erroneous contact is being made to the touchpad 102. That is, the contact is not a result of a normal user operation where the user contacts the touchpad 102 using his/her fingers or the like. Therefore, in cases where erroneous contact is being made to the touchpad 102, it is necessary to prevent the target key from being determined and accordingly to prevent the processing allocated to the target key (referred to as “key allocated processing” hereinafter) from being erroneously executed. Erroneous contact as referred to herein includes contact being made to the touchpad 102 in such cases as where a user's face or the like contacts the touchpad 102 during a call, or where an object which is put in user's bag along with the portable communication terminal contacts the touchpad 102 of the portable communication terminal.

Further, with regards to the above-stated predetermined number of keys according to which multiple key press is determined, the predetermined number of keys is to be set to a number of keys which cannot be simultaneously contacted when the user is making operations to the keys by using his/her finger or the like. In the following description, the predetermined number of keys is set presuming that, when the user is using one finger to make key operations on the touchpad 102, the maximum number of keys the user can simultaneously contact is four. The four keys which can be simultaneously contacted in such a case include: a key the user intends to press; a key located either to the right of or to the left of the intended key; a key located either above or below the intended key; and a key adjacent to the intended key in a diagonal direction. Therefore, based on this presumption, multiple key press is determined in cases where five or more keys are detected having key contact values equal to or greater than the multiple key press detection threshold. Further, in the following description, it is also presumed that, once the key determination unit 113 determines the target key, the determination of a subsequent target key is not performed until the key contact values of all of the keys of the touchpad 102 fall below or equal the release detection threshold.

The event notification unit 114 notifies the application execution unit 120 of a short press event when the key determination unit 113 determines the target key. In addition to this, the event notification unit 114 notifies the application execution unit 120 of a cancel event and a long press event based on whether the long-press time duration has been elapsed since the start of press of the target key.

Here, the short press event is an event indicating that a key has been pressed, and includes identification information of the target key which is the key having been pressed.

The cancel event is an event cancelling the short press event that has been notified immediately before the cancel event, and includes the identification information of the same target key as one included in the cancelled short press event.

The long press event is an event indicating that the long-press time duration has elapsed since the start of press of a key, and includes identification information of the target key that has been pressed.

The call processing unit 115 is provided with the functions of acquiring a telephone number allocated to the target key from the address book 10 in the storage unit 104 in accordance with an instruction from the application execution unit 120, and making a call to the acquired telephone number.

The audio processing unit 116 performs D/A (Digital/Analog) conversion of audio signals received via the communication unit 108 and outputs the converted audio signals via the speaker 105. Additionally, the audio processing unit 116 performs A/D (Analog/Digital) conversion on audio signals input from the microphone 106, and transmits the converted audio signals via the communication unit 108.

The display control unit 117 causes the sub LCD 101 to display images and the like according to instructions received from the application execution unit 120. Additionally, the display control unit 117 updates the display status information stored in the storage unit 104.

The application execution unit 120 is an event-driven application which executes processing in accordance with the event notified from the control unit 110.

<Key Contact Value>

In the following, description is made on how a key contact value of a key contacted by a user's finger or the like changes according to which mode the calculation unit 111 is in, with reference to the accompanying FIG. 6.

FIG. 6 illustrates the change observed in a key contact value calculated by the calculation unit 111.

In FIG. 6, the horizontal axis indicates time, whereas the vertical axis indicates a key contact value of a specific key which has been contacted by a user's finger or the like. Note that FIG. 6 does not illustrate the change of the key contact value when the key contact value is between 0 and 511. Further, the GND level (set to “512”, for example) illustrated in FIG. 6 is a threshold for judging whether a key is in contact with the user's finger or the like.

In addition, in the following description, it is presumed that the interval between times T1 and T2 in FIG. 6 and the interval between times T5 and T7 in FIG. 6 are commonly 100 ms. Further, it is presumed that the calculation unit 111 is in adjustment mode at time T1.

Time T1 indicates a timing at which contact to a certain key by a user's finger or the like is started.

When contact is made to the key, the value which increases/decreases according to the increase/decrease of contact area within the coordinate area corresponding to the key exceeds the key press detection threshold. However, since the calculation unit 111 is in adjustment mode between times T1 and T2, the calculation unit 111 performs adjustment to the value associated with the key, and sets the adjusted value as the key contact value. More specifically, the key contact value calculated is a value having been adjusted such that the change thereof during the unit interval (25 ms, in this example) is within a predetermined value (set to “30”, in this example). Hence, the key contact value of the key increases in a staircase-like manner between times T1 and T2.

Time T2 indicates a timing at which the key contact value of the key equals or exceeds the key press detection threshold.

Since the switching unit 112 is configured to cause the calculation unit 111 to switch to non-adjustment mode when the key contact value equals or exceeds the key press detection threshold, the calculation unit 111 is switched to non-adjustment mode at time T2. As a result, from this point, the calculation unit 111 sets the value which increases/decreases according to the increase/decrease of contact area within the coordinate area corresponding to the contacted key as the key contact value without performing adjustment thereto, and thus, the key contact value increases rapidly between times T2 and T3. Following this, and until time T5, the key contact value changes according to the increase/decrease in the area to which contact is made within the coordinate area of the touchpad 102 corresponding to the key.

Time T4 indicates a timing at which the contact to the key by the user's finger or the like is released. As mentioned above, the contact to the key by the user's finger or the like has been started at time T1.

Since the calculation unit 111 is still in non-adjustment mode between times T4 and T5, the key contact value decreases rapidly.

Time T5 indicates a timing at which the key contact value equals or falls below the release detection threshold.

Since the switching unit 112 is configured to cause the calculation unit 111 to switch to adjustment mode when the key contact value falls below or equals the release detection threshold, the calculation unit 111 is switched to adjustment mode at time T5. As a result, the calculation unit 111 performs adjustment to the value which increases/decreases according to the increase/decrease of contact area within the coordinate area corresponding to the key, and sets the adjusted value as the key contact value. More specifically, the key contact value calculated is a value having been adjusted such that the change thereof during the unit interval (25 ms) is within a predetermined value (30). Hence, the key contact value of the key decreases in a staircase-like manner between times T5 and T6.

By causing the calculation unit 111 to switch between the two modes as described above, the risk of processing allocated to keys other than the key whose processing the user intended to execute being performed (erroneous operation) is reduced in the mobile phone 100. At the same time, such a configuration makes it possible for the mobile phone 100 to respond quickly to continuous key operations performed by the user.

In the following, the effects yielded by configuring the calculation unit 111 to switch between the two modes thereof are described in further detail.

As description has already been made in the above, a key contact value is calculated by the calculation unit 111 based on the at least one electrostatic capacity value which is output from the touchpad 102. Here, it should be noted that the electrostatic capacity value also changes when affected by noises. Such noises are generated when phone calls are made, or photographs are taken utilizing a camera function provided to a conventional mobile phone.

Further, as described in the above, the key determination unit 113 determines a key having a key contact value equal to or greater than the key press detection threshold (632) as the target key, and the mobile phone 100 executes the processing allocated to the determined target key. Such being the case, the change of key contact values occurring due to noise is problematic. That is, in a case where key contact values suddenly exceed the key press detection threshold by being affected by noise, there is a risk of erroneous operation.

However, such erroneous operation is appropriately prevented by the structure of the present embodiment. As already mentioned in the above, the calculation unit 111 operates in adjustment mode between time T1 being the timing at which contact to the key is started and time T2 being the timing at which the key contact value of the contacted key equals or exceeds the key press detection threshold. Therefore, the calculation unit 111 outputs, as the key contact value, a value which has been adjusted such that the change thereof during the unit interval is within the predetermined value (30). Hence, a case is appropriately prevented where the key contact values suddenly exceed the key press detection threshold due to being affected by noise, and accordingly, the occurrence of erroneous operation as mentioned above is prevented.

In addition, and as already has been mentioned in the above, once the target key has been determined, the key determination unit 113 does not perform the determination of a subsequent target key until contact being made to all of the keys is released and the key contact values of all keys on the touchpad 102 have fallen below or equal to the release detection threshold. As such, the calculation unit 111 operates in non-adjustment mode between times T2 and T5. Thus, when the user's finger or the like is released at time T4, the key contact value of the contacted key decreases rapidly, until the key contact value equals the release detection threshold at time T5 in FIG. 6.

Thus, for example, if supposing that the key corresponding to the key contact value illustrated in FIG. 6 is the only key contacted by the user's finger or the like, the determination of a subsequent target key will be made possible after time T5. Therefore, when compared to a case where the calculation unit 111 operates in adjustment mode between times T2 and T5, the mobile phone is able to respond with an enhanced level of quickness to continuous key operations by the user.

<Operation>

<Control Processing>

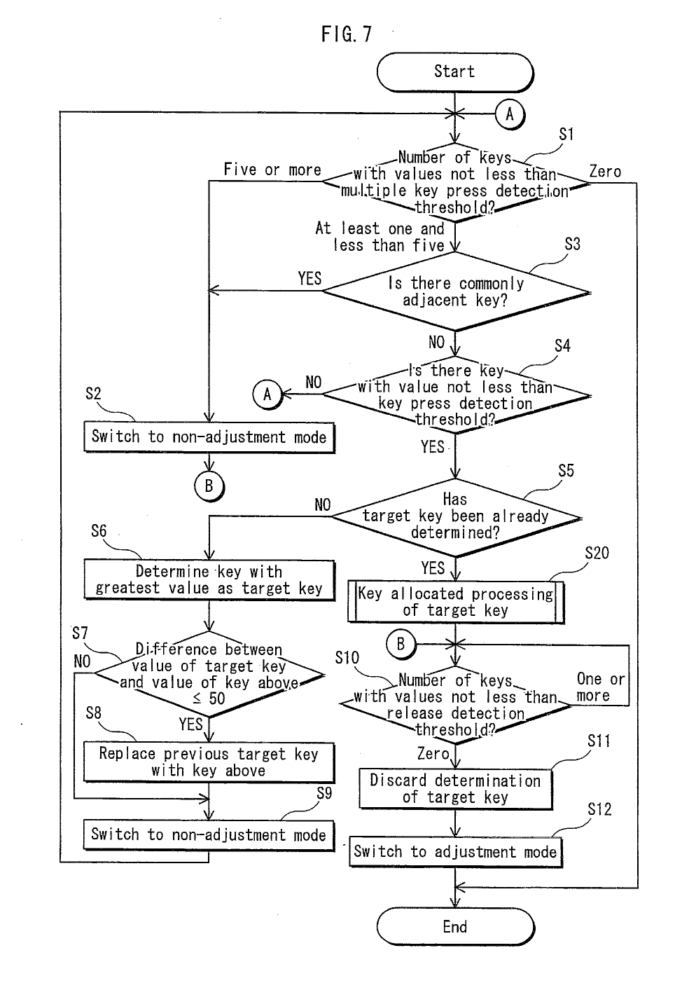

In the following, description is provided on the operation of the mobile phone 100 having the aforementioned structure, with reference to the accompanying FIG. 7.

FIG. 7 is a flowchart illustrating control processing performed by the mobile phone 100 in response to input from the touchpad 102.

Note that, separately from the control processing shown in FIG. 7, the touchpad 102 outputs at least one pair of values that each consist of a coordinate value (x, y) indicating a position on the touchpad 102 to which contact is made and a value indicating the electrostatic capacity of the contacted position, every time a unit interval (25 [ms] in this example) elapses. A key contact value is calculated by the calculation unit 111 of the control unit 110 for each key to which contact is being made, every time a unit interval elapses. Additionally, the following description is made under the presumption that the calculation unit 111 is initially in adjustment mode.

In addition, the control processing shown in FIG. 7 is repeatedly performed.

As illustrated in FIG. 7, the key determination unit 113 of the control unit 110 determines the number of keys having key contact values equal to or greater than the multiple key press detection threshold repeatedly (every 100 ms, in this example) (step S1). The determination is made based on the latest key contact values of each of the keys calculated by the calculation unit 111.

When none of the keys has a key contact value equal to or greater than the multiple key press detection threshold (step S1: zero), the key determination unit 113 terminates the control processing without performing any processing.

When there are five or more keys having key contact values equal to or greater than the multiple key press detection threshold (step S1: five or more), the switching unit 112 causes the calculation unit 111 to switch to non-adjustment mode (step S2), and the processing proceeds to the later-described step S10.

In step S2, the calculation unit 111 is caused to switch to non-adjustment mode to allow the determination of the next target key to be performed as quickly as possible. More specifically, when multiple key press is detected, the calculation unit enters non-adjustment mode from adjustment mode as described above. Thus, when the contact made to the keys is released, the key contact values of all of the keys to which contact had been made rapidly falls below the key press detection threshold.

Further, the processing proceeds to step S10 to prevent the execution of a later-described key allocated processing of step S20 (erroneous operation). Such configuration is made in view of cases of multiple key press, where it is assumed that the contact made to the touchpad 102 is not a result of a normal user operation performed by the user by using of his/her fingers or the like, and thus there is a need of preventing the key allocated processing of step S20 described later from being executed.

In step S1, when there are one to four keys having key contact values equal to or greater than the multiple key press detection threshold (step S1: at least one and less than five), the key determination unit 113 judges whether there is a key (i) which is positioned between, that is, commonly adjacent to a combination of two of the one to four keys having key contact values equal to or greater than the multiple key press detection threshold, and (ii) which has a key contact value which is smaller than or equal to the release detection threshold (step S3). This judgment is performed with respect to all combinations of two of one to four keys having key contact values equal to or greater than the multiple key press detection threshold. When it is judged that there is such a key, it is assumed that the contact to the keys has not resulted from a normal user operation made by the user with use of his/her finger or the like. Such configuration is made since there is a need of preventing the execution of key allocated processing in such a case (erroneous operation).

In addition, the above judgment of step S5 can be performed with respect to two keys which have key contact values equal to or greater than the multiple key press detection threshold and which, however, do not belong to the same horizontal row or the same vertical row. For example, supposing that when the 1 key and the 8 key have key contact values equal to or greater than the multiple key press detection threshold, the key determination unit 113 determines, as a key commonly adjacent to both the 1 key and the 8 key, a key (i) which is located in the horizontal row in between the horizontal rows in which the 1 key and the 8 key are located, and (ii) which is, at the same time, located in the vertical rows including and in between the vertical rows in which the 1 key and the 8 key are located (the 4 key and the 5 key, in this example).

Similarly, when four keys, namely the 1 key, the 3 key, the 4 key, and the 6 key, have key contact values equal to or greater than the multiple key press detection threshold, the key determination unit 113 determines, as keys commonly adjacent to two of the four keys, the 2 key and the 5 key, and further judges whether at least one of the 2 key and the 5 key has a key contact value which is smaller than or equal to the release detection threshold. A positive judgment is made (step S3: YES) when at least one of the 2 key and the 5 key, in this example, has a key contact value smaller than or equal to the release detection threshold, while, on the other hand, a negative judgment is made (step S3: NO) when both the 2 key and the 5 key have key contact values greater than the release detection threshold.

In the judgment of step S3, when there is no key commonly adjacent to combinations of two of the less than five keys having key contact values equal to or greater than the multiple key press detection threshold, the key determination unit 113 makes a negative judgment (step S3: NO). One example is when the 1 key and the 2 key have key contact values equal to or greater than the multiple key press detection threshold. Since there is no key commonly adjacent to the 1 key and the 2 key, the key determination unit 113 makes a negative judgment.

In a case where there is a key (i) which is commonly adjacent to a combination of two keys having key contact values equal to or greater than the multiple key press detection threshold and (ii) which has a key contact value smaller than or equal to the release detection threshold (step S3: YES), the switching unit 112 causes the calculation unit 111 to switch to non-adjustment mode from adjustment mode (step S2), and processing proceeds to the later-described step S10. In contrast, when there are one or more keys adjacent to combinations of two keys having key contact values equal to or greater than the multiple key press detection threshold, but the one or more keys have key contact values greater than the release detection threshold (step S3: NO), the key determination unit 113 judges whether there is a key having a key contact value equal to or greater than the key press detection threshold among the keys having key contact values equal to or greater than the multiple key press detection threshold. Note that the keys having key contact values equal to or greater than the multiple key press detection threshold have been preemptively detected in step S1 (step S4).

When none of the keys has a key contact value equal to or greater than the key press detection threshold (step S4: NO), the processing restarts from step S1. When there is a key having a key contact value equal to or greater than the key press detection threshold (step S4: YES), the key determination unit 113 subsequently judges whether the target key has been already determined (step S5).

When the target key has not yet been determined (step S5: NO), the key determination unit 113 determines the key having the highest key contact value, among the keys having key contact values equal to or greater than the key press detection threshold, as the target key (step S6). In a case where two or more keys have the same highest key contact value, the target key is determined according to a predetermined order of priority of the keys. In this example, description is made under the presumption that keys which are located closer to the upper left edge of the touchpad are given a higher priority. For instance, when three keys, namely the 1 key, the 2 key and the 4 key, have the same highest key contact value, the 1 key is determined as the target key.

In addition to this, the key determination unit 113 judges whether a value obtained by subtracting, from the key contact value of the target key, a key contact value of a key located directly above the target key is smaller than or equal to a predetermined value (set to “50”, in this example) (step S7). When the value obtained in step S7 is greater than the predetermined value (step S7: NO), the switching unit 112 causes the calculation unit 111 to switch to non-adjustment mode from adjustment mode (step S9), and processing restarts from step S1.

When the value obtained by subtracting a key contact value of a key located directly above the target key from the key contact value of the target key is smaller than or equal to the predetermined value (step S7: YES), the key determination unit 113 replaces the previous target key (the key having the highest key contact value) with a new target key which is the key directly above the previous target key (step S8). Further, the switching unit 112 causes the calculation unit 111 to switch to non-adjustment mode from adjustment mode (step S9), and processing restarts from step S1.

The processing of step S8 is incorporated as a countermeasure for such a case as where a pad of a finger, for example, contacts a key directly below the key which the user intended to press. In such a case, the key directly below the intended key will have the highest key contact value, which is problematic. Thus, in step S8, when the value obtained by subtracting, from the highest key contact value, the key contact value of the key directly above the key having the highest key contact value is smaller than or equal to the predetermined value (50, in this example), it is determined that the key which the user actually intended to contact is the key directly above the key having the highest key contact value. Therefore, the key directly above the key having the highest key contact value is newly determined as the target key.

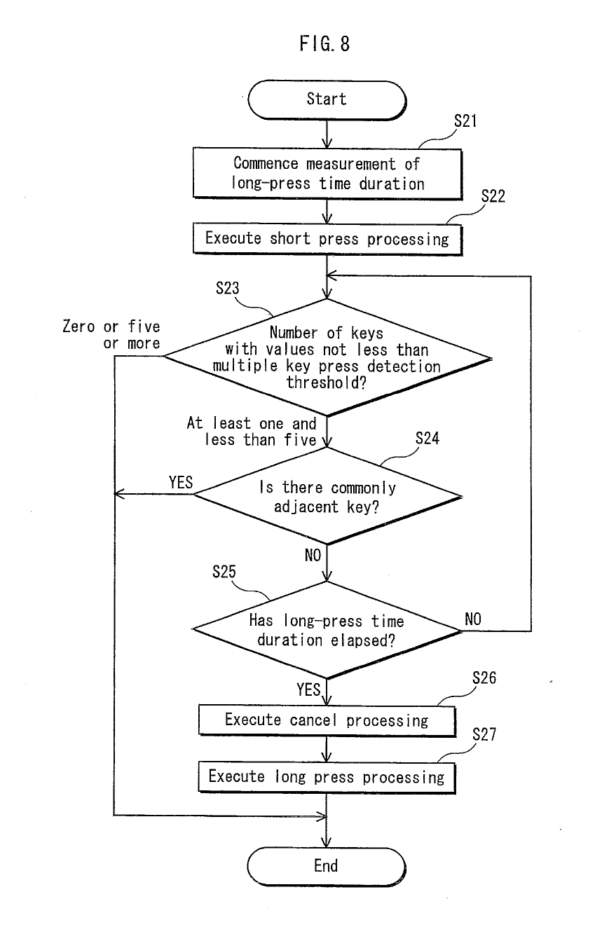

When it is judged that in step S5, the target key has already been determined (step S5: YES), key allocated processing of the target key is executed (step S20). Such key allocated processing of the target key is described later (refer to FIG. 8).

When the key allocated processing is complete, the key determination unit 113 determines the number of keys having key contact values equal to or greater than the release detection threshold (step S10). The judgment here is made based on the latest key contact values each of which have been calculated by the calculation unit 111.

When one or more keys have key contact values equal to or greater than the release detection threshold (step S10: one or more), the judgment of step S10 is performed repeatedly (every 100 ms, in this example). When none of the keys has a key contact value equal to or greater than the release detection threshold (step S10: zero), the key determination unit 113 discards the determination of the target key (step S11), and the switching unit 112 causes the calculation unit 111 to switch to adjustment mode from non-adjustment mode (step S12), and the control processing terminates.

<Key Allocated Processing of the Target Key>

In the following, description is provided on the key allocated processing of the target key in step S20.

FIG. 8 is a flowchart illustrating key allocated processing of the target key (step S20 in FIG. 7) performed by the mobile phone 100.

The key determination unit 113 causes the time measuring unit 103 to commence measurement of time (step S21). The event notification unit 114 notifies the application execution unit 120 of a short press event including identification information of the target key. Then, based on the short press event, the application execution unit 120 executes short press processing allocated to the target key (step S22).

Note that when the event notification unit 114 makes a notification of the short press event, the display control unit 117 updates the display status information in the storage unit 104 so as to indicate the status of the screen that is being displayed.

Further, the short press processing is, for example, processing for instructing the display control unit 117 to display, on the sub LCD 101, a number or the like indicating the target key, which is identified by the identification information included in the short press event. The “number or the like indicating the target key” includes a number or a symbol assigned to the target key, and for example, if the 1 key is the target key, “1” is displayed on the sub LCD 101, whereas if the star key (*) is the target key, “*” is displayed on the sub LCD 101.

Upon receiving the instruction, the display control unit 117 displays the number or the like indicating the target key on the sub LCD 101, and updates the display status information so as to indicate the screen on which the number or the like indicating the target key is displayed.

Subsequently, the key determination unit 113 determines, in a similar manner to step S1 described above, the number of keys having key contact values equal to or greater than the multiple key press detection threshold (step S23). The determination here is made based on the latest key contact values each of which have been calculated by the calculation unit 111.

In step S23, when there are one to four keys having key contact values equal to or greater than the multiple key press detection threshold (step S23: at least one and less than five), the key determination unit 113 judges, in a similar manner to step S3 described above, whether there is a key (i) which is commonly adjacent to a combination of two of the one to four keys having key contact values equal to or greater than the multiple key press detection threshold and (ii) which has a key contact value which is smaller than or equal to the release detection threshold (step S24).

When there are one or more keys adjacent to combinations of two keys having key contact values equal to or greater than the multiple key press detection threshold, but the one or more keys have key contact values greater than the release detection threshold (step S24: NO), the key determination unit 113 judges whether the long-press time duration has elapsed (step S25). Specifically, when the time measuring unit 103 notifies the key determination unit 113 that the long-press time duration has elapsed, the key determination unit 113 judges in the affirmative (step S25: YES).

When it is judged that the long-press time duration has elapsed (step S25: YES), the event notification unit 114 notifies the application execution unit 120 of a cancel event including the identification information of the target key. Then the application execution unit 120 executes cancel processing for canceling the short press processing allocated to the target key based on the cancel event (step S26).

Here, the cancel processing is for undoing the short press processing executed in step S22. More specifically, in the example of the short press processing described above, the display control unit 117 is instructed to restore a state of display on the sub LCD 101 to a previous state of display, based on the display status information stored in the storage unit 104, the previous state representing a state before the short press processing. That is, in the above example, the display control unit 117 restores the state of the display so as not to display the number or the like indicating the target key, which is identified by the identification information included in the short press event.

Upon receiving this instruction, based on the display status information stored on the storage unit 104, the display control unit 117 causes the sub LCD 101 to display the screen, which is to be displayed before execution of processing relating to display based on the short press event notified in step S22. Then, the display control unit 117 updates the display status information so as to indicate the status of the screen that is being displayed.

Subsequently, the event notification unit 114 notifies the application execution unit 120 of a long press event including the identification information of the target key. The application execution unit 120 executes long press processing allocated to the target key based on the long press event (step S27), and the key allocated processing of the target key terminates.

Here, the long press processing is for instructing the call processing unit 115 of the control unit 110 to automatically make a call to a predetermined telephone number, and at the same time, instructing the display control unit 117 of the control unit 110 to display the predetermined telephone number on the sub LCD 101, for example. The predetermined telephone number has been allocated beforehand to the target key indicated by the identification information included in the long press event.

On receiving the instruction, the call processing unit 115 acquires a telephone number associated with the target key from the address book 10 in the storage unit 104 and makes a call to the telephone number. The display control unit 117 displays the telephone number on the sub LCD 101, and updates the display status information in the storage unit 104. Note that when no telephone number has been registered in the address book 10 in the storage unit 104 as a telephone number associated with the target key, the call processing unit 115 triggers no processing, and the display control unit 117 may display a notification that informs the user that a telephone number associated with the target key has not been registered or may display nothing.

Further, in step S25, when it is judged that the long-press time duration has not yet elapsed (step S25: NO), the processing restarts from step S23. In step S23, when it is judged that the number of keys having key contact values equal to or greater than the multiple key press detection threshold is zero or five or more (step S23: zero or five or more), no processing is triggered and the key allocated processing of the target key terminates.

When the number of keys having key contact values equal to or greater than the multiple key press detection threshold is five or more, this means that multiple key press has been detected after determination of the target key. Therefore, the key allocated processing of the target key terminates so that the long press processing is not executed.

Further, when the number of keys having key contact values equal to or greater than the multiple key press detection threshold is zero, the key allocated processing of the target key terminates. This is because, in this example, the multiple key press detection threshold and the release detection threshold are the same value, and when the number of keys having key contact values equal to or greater than the multiple key press detection threshold is zero, this means that contact is released before the long-press time duration elapses. Additionally, short press processing has been already executed in step S22, and therefore, the key allocated processing terminates without executing short press processing again.

Further, in step S23, when there are one to four keys having key contact values equal to or greater than the multiple press detection threshold (step S23: at least one and less than five) and there is a key (i) which is commonly adjacent to a combination of two keys having key contact values equal to or greater than the multiple key press detection threshold and (ii) which has a key contact value smaller than or equal to the release detection threshold (step S24: YES), the control unit 110 executes no processing and the key allocated processing of the target key terminates.

In the case where there is a key (i) which is commonly adjacent to a combination of two keys having key contact values equal to or greater than the multiple key press detection threshold and (ii) which has a key contact value smaller than or equal to the release detection threshold, it is unlikely that contact is made to the touchpad 102 by the user's finger or the like even though multiple key press is not detected. Therefore, the key allocated processing of the target key terminates so that the long press processing is not executed.

<Explanation of Operation Based on Examples>

In the following, description is made on the key allocated processing of the target key, which is in particular important in the present application, based on examples.

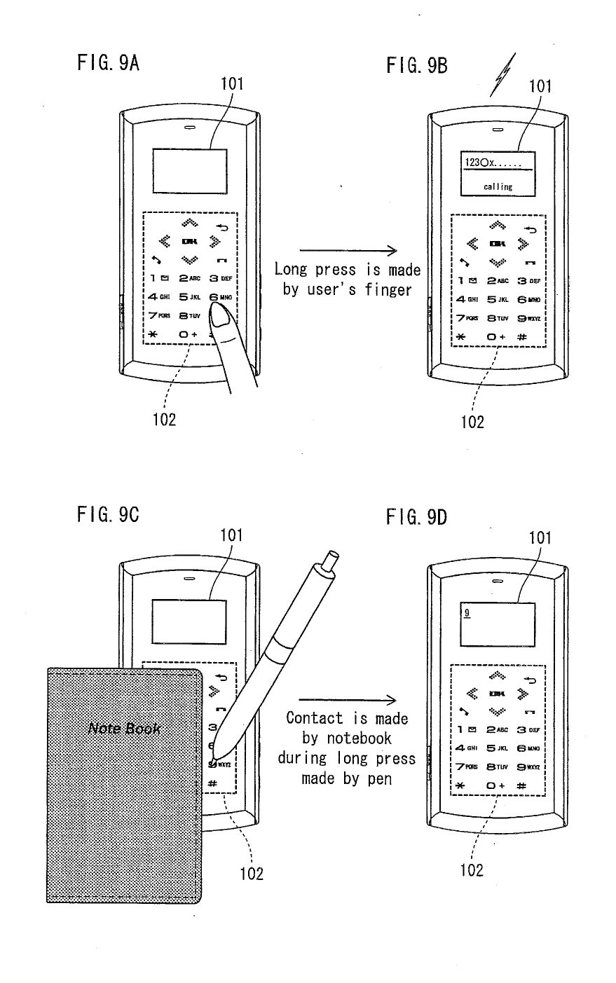

FIGS. 9A-9D illustrate examples of operation of the mobile phone 100 in response to contact of the touchpad 102.

<Contact Made by User's Finger>

Firstly, the following describes an example of operation of the mobile phone 100 in a case where contact is made to the 9 key by the user's finger as shown in FIG. 9A, with reference to the flowchart in FIG. 8.

The following description is made under the presumption that the screen of the sub LCD 101 is initially the standby screen (screen on which nothing is displayed), the 9 key has been determined as the target key, and the 9 key and the # key have key contact values equal to or greater than the multiple key press detection threshold. Additionally, it is assumed that the user's finger is still in contact with the 9 key when the long-press time duration has elapsed.

First, the key determination unit 113 causes the time measuring unit 103 to commence measurement of time (step S21 in FIG. 8). The display control unit 117 updates the display status information in the storage unit 104 so as to indicate that the screen is the “standby screen”.

In the following, the state in which the current screen is the standby screen is represented by “SET IMAGE=STANDBY SCREEN”.

The application execution unit 120 executes the short press processing allocated to the target key based on the short press event notified from the event notification unit 114 (step S22).

As a result, the display control unit 117 displays, on the sub LCD 101, the number “9” associated with the 9 key that is the target key (the number “9” is not illustrated in FIG. 9A). Then the display control unit 117 updates the display status information in the storage unit 104 so as to indicate that the screen displays the number “9” on the standby screen.

In the following, display of the number “9” is represented by “DRAW(“9”)”. “DRAW(“9”)” following “SET IMAGE=STANDBY SCREEN” is recorded in the display status information in this example.

Subsequently, the key determination unit 113 determines the number of keys having key contact values equal to or greater than the multiple key press detection threshold (step S23). In this example, the number of keys having key contact values equal to or greater than the multiple key press detection threshold is two (the 9 key and the # key) (step S23: at least one and less than five), and there is no key which is commonly adjacent to both of the 9 key and the # key (step S24: NO). Accordingly, the key determination unit 113 judges whether the long-press time duration has elapsed (step S25).

In this example, until the long-press time duration has elapsed, processing of steps S23 through S25 is repeated. When it is judged that the long-press time duration has elapsed in step S25 (step S25: YES), the application execution unit 120 executes cancel processing of short press processing allocated to the target key, based on a cancel event notified from the event notification unit 114 (step S26).

As a result, the display control unit 117 displays the standby screen (that is, a screen on which nothing is displayed) on the sub LCD 101 based on “SET IMAGE=STANDBY SCREEN” in the display status information in the storage unit 104. “DRAW(“9”)” following “SET IMAGE=STANDBY SCREEN” have been recorded in the display status information (not illustrated in FIG. 9A). Then, the display control unit 117 deletes the “DRAW(“9”)” from the display status information.

Subsequently, the application execution unit 120 executes long press processing allocated to the target key, based on a long press event notified from the event notification unit 114 (step S27), and the key allocated processing of the target key terminates.

As a result, the call processing unit 115 acquires a telephone number (123∘x . . . ) associated with the 9 key that is the target key from the address book 10 in the storage unit 104, and makes a call to the telephone number. At the same time, as shown in FIG. 9B, the display control unit 117 displays the telephone number “123∘x . . . ” and a call screen including a string of letters “calling” on the sub LCD 101. The display control unit 117 also updates the display status information in the storage unit 104 so as to indicate that the telephone number “123∘x . . . ” is displayed on the call screen.

In the above example, “SET IMAGE=CALL SCREEN” and “DRAW(“123∘x . . . ”)” are recorded in this order in the display status information following “SET IMAGE=STANDBY SCREEN”.

<Contact Made by Other Objects in User's Bag>

Secondly, as shown in FIG. 9C, the following describes an example of operation of the mobile phone 100 in a case where contact is made to the touchpad 102 by a pen and a notebook in the user's bag, with reference to the flowchart in FIG. 8.

The following description is made under the presumption that the 9 key has been already determined as the target key due to the contact made by the pen in the user's bag, and before the long-press time duration has elapsed, the notebook comes into contact with the 1 key, the 2 key, the 4 key, the 5 key, the 7 key, the 8 key, the * key, the 0 key and the like, as shown in FIG. 9C. Additionally, it is assumed that these keys have key contact values equal to or greater than the multiple key press detection threshold.

The key determination unit 113 causes the time measuring unit 103 to commence measurement of time (step S21 in FIG. 8), and the display control unit 117 updates the display status information in the storage unit 104 so as to indicate that the screen is the “standby screen”.

The event notification unit 114 notifies the application execution unit 120 of a short press event including identification information of the target key. Then, based on the short press event, the application execution unit 120 executes short press processing allocated to the target key (step S22).

As a result, as shown in FIG. 9D, the display control unit 117 displays, on the sub LCD 101, the number “9” associated with the 9 key that is the target key. Then the display control unit 117 updates the display status information in the storage unit 104 so as to indicate that the screen displays the number “9” on the standby screen.

Subsequently, in this example, the key determination unit 113 repeats processing of steps S23 through S25 in the same manner as described in the example shown by FIG. 9A. When the notebook comes into contact with the touchpad 102 and the key contact values of the keys (the 1 key, the 2 key, the 4 key, the 5 key, the 7 key, the 8 key, the * key, the 0 key and the like) become equal to or greater than the multiple key press detection threshold, the key allocated processing of the target key terminates. This is because the number of keys having the key contact values equal to or greater than the multiple key press detection threshold is five or more (step S23: zero or five or more).

As described above, when the multiple key press is detected before the long-press time duration elapses, the mobile phone 100 does not execute the long press processing allocated to the target key (in this example, call to the telephone number associated with the 9 key). As a result, the mobile phone 100 can reduce the possibility of making a call to a communication party that the user does not intend.

While not particularly shown in FIG. 9C, this applies to the case where it is judged, within a time period from the selection until the long-press time duration elapses, that there is a key (i) which is commonly adjacent to both of two keys having key contact values equal to or greater than the multiple key press detection threshold and (ii) which has a key contact value which is smaller than or equal to the release detection threshold (step S24: YES). That is, in such a case, the long press processing allocated to the target key is not executed, and it is therefore possible to reduce the possibility of making a call to a communication party that the user does not intend.

<Modification 1>

In the following, description is made on a mobile phone pertaining to modification 1. The mobile phone pertaining to modification 1 is obtained by partly modifying the key allocated processing of the target key described with reference to FIG. 8.

A mobile phone pertaining to modification 1 (referred to also as a “first modified mobile phone” hereinafter) is obtained by modifying the functions of the key determination unit 113 of the mobile phone 100 pertaining to embodiment 1 so as to provide a slightly different function thereto. Therefore, description is provided hereafter focusing on the differences between the mobile phone 100 and the first modified mobile phone.

<Operation>

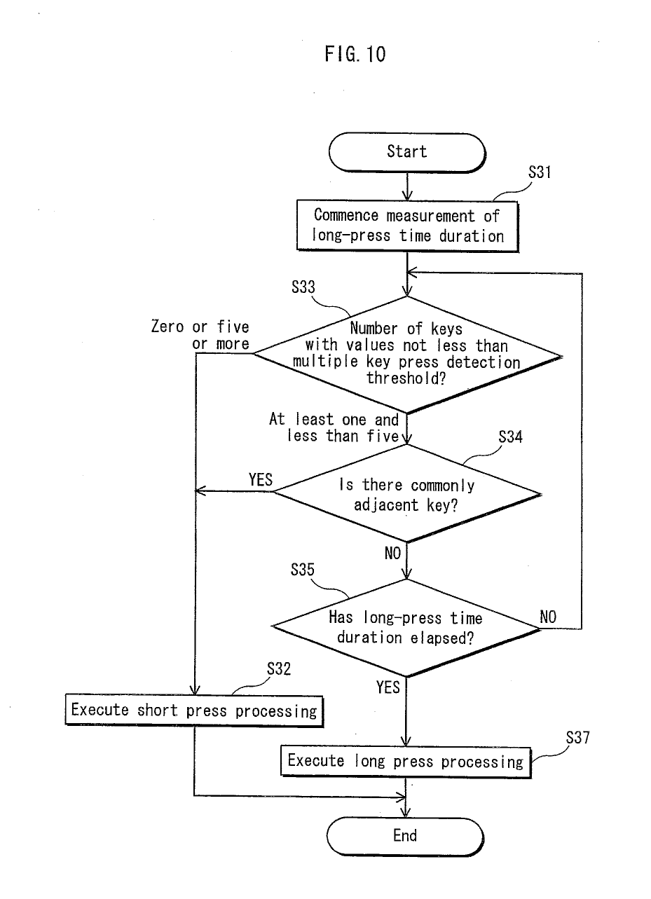

In the following, description is made on the operation of the first modified mobile phone, with reference to the accompanying FIG. 10.

FIG. 10 is a flowchart illustrating key allocated processing of the target key executed by a first modified mobile phone.

The key allocated processing of the target key executed by the first modified mobile phone shown in FIG. 10 differs from the key allocated processing of the target key executed by mobile phone 100 in the following two points: the short press processing of step S22 in FIG. 8 is executed at a different timing during the key allocated processing of the target key executed by the mobile phone 100; and cancel processing in step S26 in FIG. 8 is not executed.

That is, a key determination unit of the first modified mobile phone (referred to also as a “first modified key determination unit” hereinafter) causes the time measuring unit 103 to commence measurement of time in a similar manner to step S21 in FIG. 8 (step S31). Subsequently, without executing the short press processing, the first modified key determination unit determines the number of keys having key contact values equal to or greater than the multiple key press detection threshold in a similar manner to step S23 in FIG. 8 (step S33).

When the number of keys having key contact values equal to or greater than the multiple key press detection threshold is zero or five or more (step S33: zero or five or more), the event notification unit 114 notifies the application execution unit 120 of a short press event including identification information of the target key, in a similar manner to step S22 in FIG. 8. Then, based on the short press event, the application execution unit 120 executes short press processing allocated to the target key (step S32), and the key allocated processing of the target key terminates.

Note that when the event notification unit 114 makes a notification of the short press event, the display control unit 117 does not need to update the display status information in the storage unit 104. This is because the first modified mobile phone does not execute the cancel processing.

In step S33, when there are one to four keys having key contact values equal to or greater than the multiple key press detection threshold (step S33: at least one and less than five), the first modified key determination unit judges, in a similar manner to step S24 in FIG. 8, whether there is a key (i) which is commonly adjacent to a combination of two of the one to four keys having key contact values equal to or greater than the multiple key press detection threshold, and (ii) which has a key contact value which is smaller than or equal to the release detection threshold (step S34).

In a case where there is a key (i) which is commonly adjacent to a combination of two keys having key contact values equal to or greater than the multiple key press detection threshold and (ii) which has a key contact value smaller than or equal to the release detection threshold (step S34: YES), as described above, the application execution unit 120 executes short press processing based on the short press event notified from the event notification unit 114 (step S32), and the key allocated processing of the target key terminates.

In step S34, when there are one or more keys adjacent to combinations of two keys having key contact values equal to or greater than the multiple key press detection threshold, but the one or more keys have key contact values greater than the release detection threshold (step S34: NO), the first modified key determination unit judges whether the long-press time duration has elapsed (step S35) in a similar manner to step S25 in FIG. 8.

When it is judged that the long-press time duration has not yet elapsed (step S35: NO), the processing restarts from step S33. When it is judged that the long-press time duration has elapsed (step S35: YES), the event notification unit 114 notifies the application execution unit 120 of a long press event including the identification information of the target key in a similar manner to step S27 in FIG. 8 without causing the application execution unit 120 to execute cancel processing. Based on the long press event, the application execution unit 120 executes long press processing allocated to the target key (step S37), and the key allocated processing of the target key terminates.

<Modification 2>

In the following, description is made on a mobile phone pertaining to modification 2. The mobile phone pertaining to modification 2 is modified so as to reduce the possibility of executing call processing by detecting multiple key press. Here, multiple key press is, for example, detected within a time period from when the long-press time duration has elapses until contact made to the target key is released.

The mobile phone pertaining to modification 2 (referred to also as a “second modified mobile phone” hereinafter) is obtained by modifying the functions of the key determination unit 113 of the mobile phone 100 pertaining to embodiment 1 so as to provide a slightly different function thereto. Therefore, description is provided hereafter focusing on the differences between the mobile phone 100 and the second modified mobile phone.

<Operation>

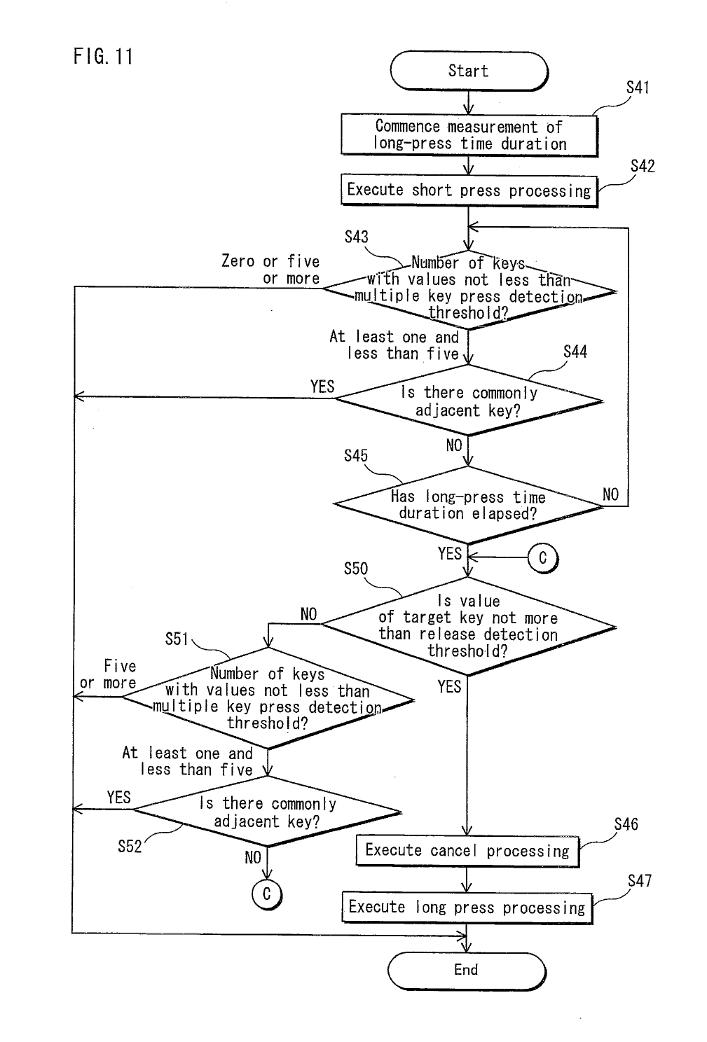

In the following, description is made on the operation of the second modified mobile phone, with reference to the accompanying FIG. 11.

FIG. 11 is a flowchart illustrating key allocated processing of a target key executed by the second modified mobile phone.

The key allocated processing of the target key executed by the second modified mobile phone shown in FIG. 11 differs from the key allocated processing of the target key executed by mobile phone 100, which is shown in FIG. 8, in the following point: steps S50 through S52 are added to the key allocated processing of the target key executed by mobile phone 100.

That is, when a key determination unit of the second modified mobile phone (referred to also as a “second modified key determination unit” hereinafter) causes the time measuring unit 103 to commence measurement of time in a similar manner to step S21 in FIG. 8 (step S41), the event notification unit 114 notifies the application execution unit 120 of a short press event including identification information of the target key, in a similar manner to step S22 in FIG. 8. Based on the short press event, the application execution unit 120 executes short press processing allocated to the target key (step S42). Note that when the event notification unit 114 makes a notification of the short press event, the display control unit 117 updates the display status information in the storage unit 104 so as to indicate the status of the screen that is being displayed.

Subsequently, the second modified key determination unit determines the number of keys having key contact values equal to or greater than the multiple key press detection threshold in a similar manner to step S23 in FIG. 8 (step S43). When the number of keys having key contact values equal to or greater than the multiple key press detection threshold is zero or five or more (step S43: zero or five or more), no processing is triggered and the key allocated processing of the target key terminates.

In step S43, when there are one to four keys having key contact values equal to or greater than the multiple key press detection threshold (step S43: at least one and less than five), the second modified key determination unit judges, in a similar manner to step S24 in FIG. 8, whether there is a key (i) which is commonly adjacent to a combination of two of the one to four keys having key contact values equal to or greater than the multiple key press detection threshold, and (ii) which has a key contact value which is smaller than or equal to the release detection threshold (step S44).

When there is a key (i) which is commonly adjacent to a combination of two keys having key contact values equal to or greater than the multiple key press detection threshold and (ii) which has a key contact value smaller than or equal to the release detection threshold (step S44: YES), no processing is triggered and the key allocated processing of the target key terminates. When there are one or more keys adjacent to combinations of two keys having key contact values equal to or greater than the multiple key press detection threshold, but the one or more keys have key contact values greater than the release detection threshold (step S44: NO), the second modified key determination unit judges whether the long-press time duration has elapsed (step S45) in a similar manner to step S25 in FIG. 8.

When it is judged that the long-press time duration has not yet elapsed (step S45: NO), the processing restarts from step S43. When it is judged that the long-press time duration has elapsed (step S45: YES), the second modified key determination unit judges whether a key contact value of the target key is smaller than or equal to the release detection threshold (step S50). This judgment is performed to judge whether contact made to the target key is released after the long-press time duration has elapsed.

In step S50, when the key contact value of the target key is equal to or greater than the release detection threshold (step S50: NO), the second modified key determination unit determines the number of keys having key contact values equal to or greater than the multiple key press detection threshold (step S51) in a similar manner to step S43 described above.

When there are five or more keys having key contact values equal to or greater than the multiple key press detection threshold (step S51: five or more), no processing is triggered and the key allocated processing of the target key terminates. When there are one to four keys having key contact values equal to or greater than the multiple key press detection threshold (step S51: at least one and less than five), the second modified key determination unit judges, in a similar manner to step S44 described above, whether there is a key (i) which is commonly adjacent to a combination of two of the one to four keys having key contact values equal to or greater than the multiple key press detection threshold, and (ii) which has a key contact value which is smaller than or equal to the release detection threshold (step S52).

Steps S51 and S52 are performed so that long press processing is not executed when an erroneous contact is made within a time period from long-press time duration has elapsed until contact made to the target key is released. Such an erroneous contact includes a case of multiple key press and a case where there is a key (i) which is commonly adjacent to a combination of two keys having key contact values equal to or greater than the multiple key press detection threshold and (ii) which has a key contact value smaller than or equal to the release detection threshold.

In step S52, in a case where there is a key (i) which is commonly adjacent to a combination of two keys having key contact values equal to or greater than the multiple key press detection threshold and (ii) which has a key contact value smaller than or equal to the release detection threshold (step S52: YES), no processing is triggered and the key allocated processing of the target key terminates. When there are one or more keys adjacent to combinations of two keys having key contact values equal to or greater than the multiple key press detection threshold, but the one or more keys have key contact values greater than the release detection threshold (step S52: NO), the processing restarts from step S50.

In step S50, when the key contact value of the target key is smaller than or equal to the release detection threshold (step S50: YES), in a similar manner to step S26 in FIG. 8, the event notification unit 114 notifies the application execution unit 120 of the cancel event including the identification information of the target key. Based on the cancel event, the application execution unit 120 executes cancel processing for canceling the short press processing allocated to the target key (step S46).

Subsequently, in a similar manner to step S27 in FIG. 8, the event notification unit 114 notifies the application execution unit 120 of a long press event including the identification information of the target key. Based on the long press event, the application execution unit 120 executes long press processing allocated to the target key (step S47), and the key allocated processing of the target key terminates.

<Modification 3>

In the following, description is made on an example of an approach for reducing the possibility of making a call by an abnormal contact, that is, contact on the touchpad 102 made by objects other than the user's finger. Such an approach is different from the above approach according to which it is judged whether there is a key (i) which is commonly adjacent to a combination of two keys having key contact values equal to or greater than the multiple key press detection threshold and (ii) which has a key contact value smaller than or equal to the release detection threshold. Note that the above approach is described in step S3 in FIG. 7 and step S24 in FIG. 8.

The mobile phone pertaining to modification 3 (referred to also as a “third modified mobile phone” hereinafter) is obtained by modifying the functions of the key determination unit 113 of the mobile phone 100 pertaining to embodiment 1 so as to provide a slightly different function thereto. Therefore, description is provided hereafter focusing on the differences between the mobile phone 100 and the third modified mobile phone.

<Operation>

<Control Processing>

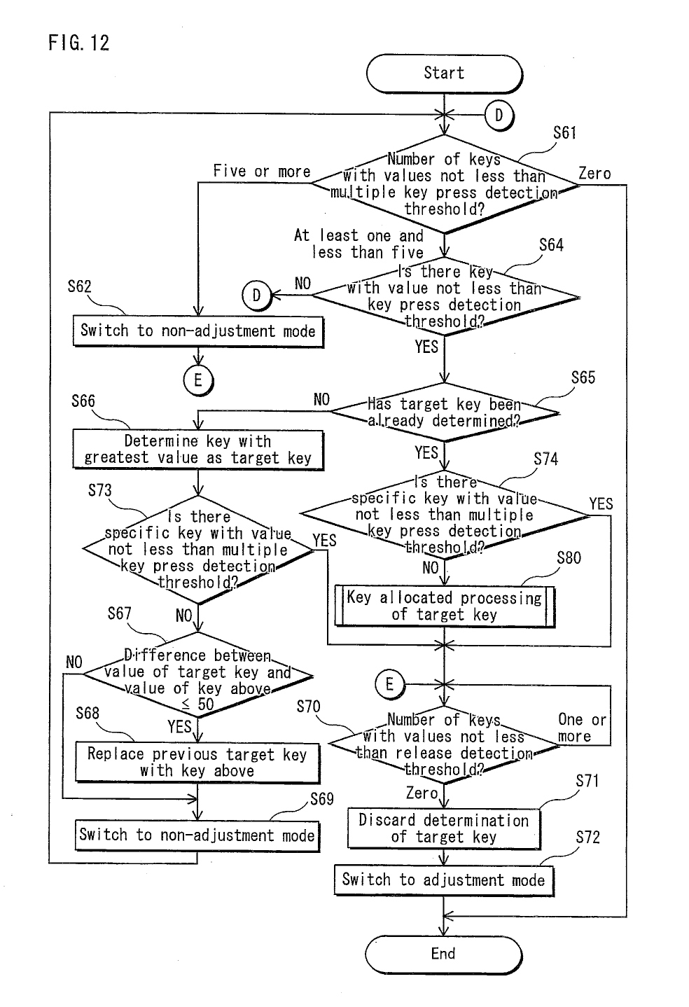

In the following, description is made on the operation of the third modified mobile phone, with reference to the accompanying FIG. 12.

FIG. 12 is a flowchart illustrating control processing executed by the third modified mobile phone in response to input from the touchpad 102.

As illustrated in FIG. 12, the control processing of the third modified mobile phone differs from that of the mobile phone 100 in that processing of step S3 in FIG. 7 is not included, whereas processing of steps S73 and S74 is incorporated.

In a similar manner to step S1 in FIG. 7, the key determination unit of the third modified mobile phone (referred to also as a “third modified key determination unit” hereinafter) determines the number of keys having key contact values equal to or greater than the multiple key press detection threshold (step S61). The determination is made based on the latest key contact values each of which have been calculated by the calculation unit 111. When it is determined that one to four keys have key contact values equal to or greater than the multiple key press detection threshold (step S61: at least one and less than five), in a similar manner to step S4 in FIG. 7, the third modified key determination unit judges whether there is a key having a key contact value equal to or greater than the key press detection threshold among the keys having key contact values equal to or greater than the multiple key press detection threshold. The keys having key contact values equal to or greater than the multiple key press detection threshold have been determined in step S61 (step S64).

When there is a key having a key contact value equal to or greater than the key press detection threshold (step S64: YES), the third modified key determination unit judges whether the target key has already been determined (step S65), in a similar manner to step S5 in FIG. 7. When the target key has not yet been determined (step S65: NO), the third modified key determination unit determines the key having the greatest key contact value, among the keys having key contact values equal to or greater than the key press detection threshold, as the target key (step S66), in a similar manner to step S6 in FIG. 7.

The third modified key determination unit judges whether one or more of the keys (referred to hereinafter as “specific keys”) of the touchpad 102 excluding (i) the keys adjacent to the target key and (ii) the key located two keys below the target key in the vertical row, have key contact values equal to or greater than the multiple key press detection threshold (step S73). For instance, when the 5 key is the target key, the specific keys are keys of the touchpad 102 excluding keys 1-4, keys 6-9, and the 0 key. Similarly, when the 4 key is the target key, the specific keys are keys of the touchpad 102 excluding keys 1, 2, 5, 7, 8, and the star key (*).

When one or more of the specific keys have key contact values equal to or greater than the multiple key press detection threshold (step S73: YES), the third modified key determination unit proceeds to the processing of step S70. This is because when the user makes key operations on the touchpad 102 by using his/her finger or the like, simultaneous contact cannot be made to the target key and a specific key, under the presumption that when the user makes key operations on the touchpad 102 by using his/her finger or the like, the maximum number of keys which may be simultaneously contacted is four. Further, the reason why the key located two keys below the target key in the vertical row is not included in the specific keys is because there is a possibility of the finger pad falling into contact with the key located two keys below the target key, even in a case where the user is controlling the keys of the touchpad using his/her finger or the like.

When all of the one or more specific keys have key contact values smaller than the multiple key press detection threshold (step S73: NO), the third modified key determination unit judges whether a value obtained by subtracting, from the key contact value of the target key, a key contact value of a key located directly above the target key is smaller than or equal to a predetermined value (50) (step S67). This judgment is similar to one explained with regards to steps S7 through S9 in FIG. 7. The third modified key determination unit changes the target key (step S68) based on the result of the judgment. The switching unit 112 causes the calculation unit 111 to switch to non-adjustment mode from adjustment mode (step S69). Subsequently, processing restarts from step S61.

When it is judged that the target key has been already determined after steps S61, S64, and S65 have been performed as in the above (step S65: YES), the third modified key determination unit judges whether one or more of the specific keys have key contact values equal to or greater than the multiple key press detection threshold (step S74). Note that step S74 is similar to the above-described step S73.

The judgment as to whether one or more of specific keys have key contact values equal to or greater than the multiple key press detection threshold is performed once again in step S74 since there are cases where contact to the specific keys occurs later than the contact to the target key.

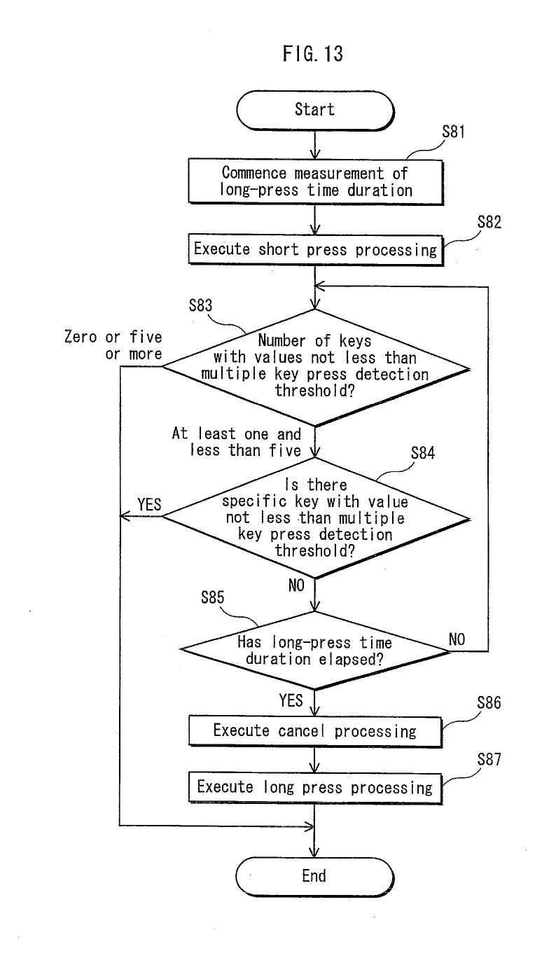

When one or more of the specific keys have key contact values equal to or greater than the multiple key press detection threshold (step S74: YES), the third modified key determination unit proceeds to the processing of step S70 without performing any processing. When all of the one or more specific keys have key contact values smaller than the multiple key press detection threshold (step S74: NO), key allocated processing of the target key is executed (step S80). Such key allocated processing of the target key is described later (refer to FIG. 13).

When the key allocated processing of the target key completes, the third modified key determination unit determines the number of keys having key contact values equal to or greater than the release detection threshold (step S70). The determination is made based on the latest key contact values of each of the keys calculated by the calculation unit 111. When none of the keys has a key contact value equal to or greater than the release detection threshold (step S70: zero), the third modified key determination unit discards the determination of the target key (step S71), and the switching unit 112 switches to adjustment mode from non-adjustment mode (step S72). Then, the control processing terminates. Note that steps S70 through S72 are similar to steps S10 through S12 in FIG. 7.

<Key Allocated Processing of the Target Key>

In the following, description is provided on the key allocated processing of the target key of step S80.

FIG. 13 is a flowchart illustrating key allocated processing of a target key (step S80 in FIG. 12) performed by the third modified mobile phone.

The key allocated processing of the target key of the third modified mobile phone shown in FIG. 13 differs from that of the mobile phone 100 shown in FIG. 8 in that step S84 is included instead of step S24 of the key allocated processing of the target key of the mobile phone 100.

That is, in a similar manner to steps S21 through S23 in FIG. 8, the third key determination unit causes the time measuring unit 103 to commence measurement of time (step S81), the application execution unit 120 executes short press processing allocated to the target key, based on a short press event notified from the event notification unit 114 (step S82), and the third modified key determination unit determines the number of keys having key contact values equal to or greater than the multiple key press detection threshold (step S83).

In step S83, to be specific, when there are one to four keys having key contact values equal to or greater than the multiple key press detection threshold (step S83: at least one and less than five), the third modified key determination unit judges whether one or more of the specific keys have key contact values equal to or greater than the multiple key press detection threshold (step S84). Note that step S84 is similar to the above-described steps S73 and S74.

In step S84, when one or more of the specific keys have key contact values equal to or greater than the multiple key press detection threshold (step S84: YES), the key allocated processing of the target key terminates without performing any processing. When all of the one or more specific keys have key contact values smaller than the multiple key press detection threshold (step S84: NO), the third modified key determination unit judges whether the long-press time duration has elapsed (step S85) in a similar manner to step S25 in FIG. 8.

In step S85, to be specific, when it is judged that the long-press time duration has elapsed (step S85: YES), the application execution unit 120 executes cancel processing based on a cancel event notified from the event notification unit 114 (step S86), and executes long press processing allocated to the target key based on a long press event notified from the event notification unit 114 (step S87). Note that steps S86 and S87 are similar to steps S26 and S27 in FIG. 8. Then the key allocated processing of the target key terminates.

<Supplement>

Although description has been made in the above on the portable communication terminal pertaining to the present invention with focus on embodiment 1 and modifications 1 through 3 thereof (referred to hereinafter simply as “exemplary embodiments”), it is to be understood that the present invention is not limited to the portable terminal as description has been made in the exemplary embodiments, and modifications as introduced below can be made without departing from the spirit and scope thereof.

(1) Although explanation has been made in the above presuming that the mobile phone pertaining to the exemplary embodiments is a flip-type mobile phone which opens in a horizontal direction with respect to the longitudinal direction thereof, the present invention is not limited to this. The mobile phone may be a flip-type mobile phone which opens in a vertical direction with respect to the longitudinal direction thereof, a bar-type mobile phone, a slider-type mobile, or mobile phones having other exterior forms, as long as the mobile phone is equipped with a touchpad.

(2) Although explanation has been made in the above that the mobile phone pertaining to the exemplary embodiments is a mobile phone to which the sub LCD 101 and the touchpad 102 are separately provided as in the illustration of FIG. 3, the present invention is not limited to this. The mobile phone pertaining to the present invention may be provided with the sub LCD 101 and the touchpad 102 in an integrated state. That is, the mobile phone may include a so-called touch panel.

Further, in providing such a touch panel to the mobile phone pertaining to the present invention, the touch panel need not be embodied as a single touch panel having both a controller part for receiving user operations and a display part for displaying characters and the like resulting from the user operations. That is, the touch panel may be provided solely for receiving input of numbers, characters and the like from the user, and the display part for displaying input characters and the like may be separately embodied as an LCD, an organic light-emitting diode (Organic Electro-Luminescence) or the like.

Additionally, the touch panel need not be realized by using a display device such as an LCD for displaying images and the like. In other words, the touch panel need not display characters and the like. Alternatively, the touch panel may be embodied as a combination of an illumination unit and a sheet disposed above the illumination unit which has transparent portions formed in the shape of characters and marks. In such a case, the user may, for example, press areas of the sheet corresponding to transparent portions on which the shapes of predetermined characters have been formed, thereby bringing about a change in the electrostatic capacity of the touchpad. Thus, the predetermined character on the sheet is input to the touchpad.

(3) In the above, it has been explained that the touchpad 102 pertaining to the exemplary embodiments of the present invention is realized with use of a capacitive touch sensor. As such a capacitive touch sensor for realizing the touchpad 102, an appropriate type is to be selected from various types of capacitive touch sensors. Types of touch sensors include: a projected capacitance touch sensor which includes multiple electrode patterns formed on a substrate composed of plastic, glass or the like and which can detect contact made to locations thereof by measuring ratios of amperages between different electrode patterns in the vicinity of the contact location; a surface capacitance touch sensor which includes a conductive layer, a substrate, and electrodes provided to the edges of the substrate, in which a uniform electrostatic field is formed by the conductive layer, and the contact location is detected by measuring a ratio between the amperages of the electrodes caused by the contact made thereto by a finger or the like. Further, with regards to the touch panel as explanation has been made in the above modification (2), an appropriate touch panel may be similarly selected as necessary from various types of touch panels.

Further, although explanation has been provided in the exemplary embodiments that the touchpad 102 is embodied by use of a capacitive touch sensor, the present invention is not limited to this. Alternatively, the touchpad 102 may be embodied as an electromagnetic induction touch sensor, a matrix switch touch sensor, a resistive touch sensor, a surface acoustic wave touch sensor, an infrared touch sensor, an optical sensor touch sensor or the like. In further explanation of each of the types of the touch sensors, an electromagnetic induction touch sensor requires the use of a special pen such as an electronic pen, a matrix switch touch sensor is composed of transparent electrodes having two-layer structures, a resistive touch sensor includes two resistive layers and voltage is applied to one resistive layer and the other resistive layer detects changes in voltage according to locations on the one resistive layer to which contact has been made, a surface acoustic wave touch sensor detects contact made by a finger or the like by detecting the reflection of ultrasonic waves by monitoring the voltage changes of piezoelectric elements, an infrared touch sensor detects a location thereof to which contact has been made by a finger or the like by using shielded infrared beams, and an optical sensor touch sensor detects a location thereof to which contact has been made by using an optical sensor provided to the screen.

(4) In the exemplary embodiments, the value of the GND, the value of the release detection threshold or the multiple key press detection threshold, and the value of the key press detection threshold are set to “512”, “580”, and “632”, respectively. However, such values have been provided for the mere sake of examples, and desirably, such values are to be determined as in the following.

As description has already been made in the above, a key contact value is calculated based on the electrostatic capacity value which is output from the touchpad 102. Therefore, it is preferable that the GND value be determined based on a preemptively-measured value indicating electrostatic capacity output from the touchpad 102 in a state where objects such as a user's finger is not in contact therewith.

Further, the electrostatic capacity value output from the touchpad 102 is subject to change even when contact is not actually being made to the touchpad 102. That is, there are cases where the electrostatic capacity value fluctuates due to noises being generated. The generation of such noises occurs by units of the mobile phone undergoing operation to perform functions allocated thereto. Such functions of the mobile phone include a telephone function, a camera function, and the like. Accordingly, it is preferable that the release detection threshold and the multiple key press detection threshold be determined by performing a preemptive measurement of the extent to which the electrostatic capacity value output from the touchpad 102 increases during the operation of such functions, and by setting the thresholds based on the result of the measurement.

Additionally, when contact is made to a key by a user's finger or the like, not only the key contact value of the contacted key changes but also the key contact values of keys which are adjacent to the contacted key but which have not actually been contacted are subject to change. In the embodiment, the difference between the value (580) of the release detection threshold or the multiple key press detection threshold, and the value (632) of the key press detection threshold is fixed to “52”. However, the present invention is not limited to this, and it is desirable that the difference between the threshold values be determined based on a result of a preemptive measurement of the extent to which each of the electrostatic capacity value of the key to which contact is actually made and the electrostatic capacity value of the keys which are adjacent to the contacted key but which have not actually been contacted increases. It is preferable that the release detection threshold and the multiple key press detection threshold be determined based on the difference determined as such.

In addition, the release detection threshold and the multiple key press detection threshold are provided with a same value (580) in the exemplary embodiments. However, the two thresholds need not be provided with a same value, and the values of the release detection threshold and the multiple key press detection threshold may be set individually.

(5) In the exemplary embodiments, description is made under the presumption that, when the user makes key operations on the touchpad 102 by using his/her finger or the like, the maximum number of keys which may be simultaneously contacted is four. Hence, description has been made that multiple key press is detected when five or more keys are contacted. However, this is merely one example, and configuration may be made such that multiple key press is detected when a predetermined number of keys are contacted, provided that the predetermined number is set to two or more. Further, when the user makes key operations to the touchpad using his/her finger or the like, the maximum number of keys which can be simultaneously contacted may vary to a certain extent according to such reasons as the size of the user's finger or the like. Thus, configuration may be made such that multiple key press is detected when a predetermined number of keys are contacted simultaneously, the predetermined number of keys being set by having the user actually perform key operations at the beginning of the use of the mobile phone pertaining to the exemplary embodiments, and counting the maximum number of keys simultaneously contacted by the user. In addition, configuration may be also made such that the user is able to set the number of keys where multiple key press is to be detected.

(6) In step S2 of FIG. 7, the state of the calculation unit 111 is caused to switch from adjustment mode to non-adjustment mode so that the determination of the subsequent target key can be performed as quickly as possible. More specifically, such prompt determination of the subsequent target key is made possible by the key contact values of the each of the keys quickly falling below the key press detection threshold when contact to the touchpad 102 has been released. However, the present invention is not limited to this, and the switching of the calculation unit from the adjustment mode to the non-adjustment mode need not be performed.

This is since, when step S2 of FIG. 7 is executed, it can be assumed that contact is being made to the touchpad 102 by an object which is put in a user's bag, rather than by a user's finger or the like as in a normal user operation. In such cases, the necessity of realizing prompt execution of processing in response to subsequent key operation is comparatively low.

In addition, the processing of step S2 of FIG. 7 may be executed only when the calculation unit 111 is in adjustment mode.

(7) In step S7 of FIG. 7, the judgment is made as to whether the difference between the key contact value of the target key (a key having the highest key contact value) and the key contact value of the key directly above the target key is smaller than or equal to a predetermined value (50, in this example). However, the present invention is not limited to this, and, the same judgment may be performed using the key contact values of the keys located directly to the left and directly to the right of the target key, in addition to the key contact value of the key directly above the target key. In such a case, a calculation is to be performed for each of the key directly above the target key, the key directly to the right of the target key, and the key directly to the left of the target key, to obtain the difference between the key contact values of the target key and each of such keys. Subsequently, when at least one of the calculated differences is smaller than or equal to the predetermined value, the target key may be determined as the key having a key contact value the difference between which and the key contact value of the previous target key being the smallest.

In addition, the difference may be calculated between the key contact value of the target key and the key contact value of either one of the key directly to the left of the target key and the key directly to the right of the target key. Further, configuration may be also made such that the user is able to select the key used for the calculation of the difference from the key directly above the target key, the key directly to the left of the target key, and the key directly to the right of the target key.

(8) Further, in step S7 of FIG. 7, judgment is made as to whether the difference between the key contact value of the target key (a key having the highest key contact value) and the key contact value of the key directly above the target key is smaller than or equal to a predetermined value (50, in this example). However, the present invention is not limited to this, and instead, a judgment may be performed as to whether the key contact value of the key directly above the target key is equal to or greater than a predetermined value which is set greater in value than the key press detection threshold. As description has been made in (7) above, a similar configuration may be made even in cases where the calculation of difference is performed using the key directly to the right of the target key and/or the key directly to the left of the target key.

It is preferable that the predetermined value which is set greater than the key press detection threshold as description has been made in the above be determined, for example, by having the user actually perform operations for several times on the portable terminal. Accordingly, the predetermined value may be determined based on the results yielded.

(9) The cancel processing, which is shown in step S26 of FIG. 8, step S46 of FIG. 11, and step S86 of FIG. 13, may not be executed. That is, the long press processing (step S27 of FIG. 8, step S47 of FIG. 11, and step S87 of FIG. 13) may be executed without undoing the short press processing.

(10) In the exemplary embodiments, a key and a telephone number are associated with each other in the address book 10, as shown in FIG. 5. However, a key and a telephone number may be associated with each other with use of a mapping table.

In this case, for example, when a user performs a specific operation, a mobile phone may perform registration on the mapping table. The registration on the mapping table may be performed as follows: a user specifies a telephone number, that is, selects a telephone number from the address book 10, or directly inputs a telephone number; and the user specifies a key with which the specified telephone number is associated.

(11) The mobile phone pertaining to modification 2 (the second modified mobile phone) may be further modified by applying modification 1 which does not include the cancel processing.

That is, short press processing of step S42 in FIG. 11 may be executed only when the number of keys having the key contact values equal to or greater than the multiple key press detection threshold is zero or five or more in step S43 or step S51 (step S43: zero or five or more, or step S51: five or more) or there is a key (i) which is commonly adjacent to a combination of two keys having key contact values equal to or greater than the multiple key press detection threshold and (ii) which has a key contact value smaller than or equal to the release detection threshold in step S44 or step S52 (step S44: YES or step S52: YES), and the cancel processing in step S46 may not be executed.

When the second modified mobile phone is modified in this manner, as described in modification 1, the display control unit 117 does not need to update the display status information in the storage unit 104.

Similarly, the mobile phone pertaining to modification 3 (the third modified mobile phone) may be further modified so as not to execute the cancel processing described in modification 1.

That is, short press processing of step S82 in FIG. 13 may be executed only when the number of keys having the key contact values equal to or greater than the multiple key press detection threshold is zero or five or more in step S83 (step S83: zero or five or more) or there is a key (i) which is commonly adjacent to a combination of two keys having key contact values equal to or greater than the multiple key press detection threshold and (ii) which has a key contact value smaller than or equal to the release detection threshold in step S84 (step S84: YES), and the cancel processing in step S86 may not be executed.

(12) It may be possible to apply, to the mobile phones pertaining to modifications 1 and 2 (the first modified mobile phone and the second modified mobile phone), the method of detecting contact made to the touchpad 102 that does not result from a normal operation performed by the user by using his/her fingers or the like, which has been explained in modification 3.

(13) Additionally, processing executed in long press processing (step S27 of FIG. 8 and the like) described in the exemplary embodiments is not limited to making a call, and may be different processing. Examples of such processing are displaying an input screen for inputting a password, recording, alarm setting, switching a manner mode, switching a speakerphone, switching power on/off, activating a camera, activating a specific application, activating video shooting, activating a screen for creating new mail and the like. Such processing may be one of or combination of any of the above.

(14) In the exemplary embodiments, description is made that the touchpad 102 sends, to the control unit 110, at least one pair of values consisting of a coordinate value (x, y) of the contacted position and an electrostatic capacity value of the contacted position, and the calculation unit 111 calculates a key contact value for each of the keys based on the at least one pair of values. However, modification may be made as described in the following.

That is, a touchpad pertaining to this modification (referred to as a “modified touchpad” hereinafter) may be configured to output, for each of the keys, a value which increases/decreases according to the size of the contacted area within a coordinate area corresponding to a key. Further, the calculation unit pertaining to this modification (referred to as a “modified calculation unit” hereinafter) may calculate a key contact value for each of the keys of the touchpad 102 according to the mode thereof (adjustment mode or non-adjustment mode).

More specifically, in such a modification, the twenty ports of the capacitive touch sensor IC (Integrated Circuit) for realizing the modified touchpad are allocated in one-to-one correspondence to the keys of the modified touchpad. A value which increases/decreases between 0-1024 according to the contacted area within the coordinate area corresponding to a key is input, for each of the keys, to the modified calculation unit via each of the ports. Further, the number of ports provided to the IC is not limited to twenty as provided in the above example, and may be changed as necessary.

(15) Further, the components on which explanation has been made in the exemplary embodiments may be partially or entirely embodied as an integrated circuit having one chip or multiple chips. Further, the components may also be embodied as a computer program or as any type of embodiment.

Further, the components explanation of which has been made in the exemplary embodiments operate in a cooperative manner with the processor included in the mobile phone, and thus, realize the functions provided thereto.

(16) It may be conceived to distribute a program for causing a CPU (Central Processing Unit) to execute the operations to be performed in response to input from the touchpad 102 (refer to FIGS. 7, 8, and 10 through 13) as explanation has been made in the exemplary embodiments. The distribution of such a program may be realized by recording the program onto recording media, or transmitting the program via various communication paths. The recording media which may be used in such distribution of the program include IC cards, optical discs, flexible disks, ROMs, flash memories, and the like. The distributed program is to be stored to a memory or the like which may be read by the CPU provided to devices, so that the CPU may access and execute the program. Thereby, each of the functions of each of the mobile phones description has been made on in the exemplary embodiments is to be realized.

(17) In the following, description is provided on a structure of a portable communication terminal pertaining to one embodiment of the present invention as well as on modifications thereof. Additionally, description is made on the advantageous effects of such portable communication terminals.

(a) A portable communication terminal pertaining to an embodiment of the present invention is a portable communication terminal comprising: a touchpad configured to detect contact made thereto and output a value indicating a degree of the contact; a selecting unit configured to select, based on the value output by the touchpad, one area from among areas on the touchpad on which contact is detected, the areas each having processing to be executed allocated thereto; a first judgment unit configured to judge whether or not the number of areas on the touchpad on which contact is detected equals or exceeds a predetermined number within a time period from the selection until a specific condition is satisfied, the specific condition including a requirement that contact made to the selected area continues to be detected for a predetermined time period from the selection; and an execution control unit configured, when the first judgment unit judges in the negative, to execute processing allocated to the selected area, and when the first judgment unit judges in the affirmative, not to execute the processing.

Further, an input control program pertaining to an embodiment of the present invention is an input control program used by a portable communication terminal including a touchpad configured to detect contact made thereto and output a value indicating a degree of the contact, the program including the steps of; selecting, based on the value output by the touchpad, one area from among areas on the touchpad on which contact is detected, the areas each having processing to be executed allocated thereto; judging whether or not the number of areas on the touchpad on which contact is detected equals or exceeds a predetermined number within a time period from the selection until a specific condition is satisfied, the specific condition including a requirement that contact made to the selected area continues to be detected for a predetermined time period from the selection; and executing processing allocated to the selected area when the first judgment unit judges in the negative, and not executing the processing when the first judgment unit judges in the affirmative.

Further, an input control method pertaining to an embodiment of the present invention is an input control method used in a portable communication terminal including a touchpad configured to detect contact made thereto and output a value indicating a degree of the contact, the method comprising the steps of: selecting, based on the value output by the touchpad, one area from among areas on the touchpad on which contact is detected, the areas each having processing to be executed allocated thereto; judging whether or not the number of areas on the touchpad on which contact is detected equals or exceeds a predetermined number within a time period from the selection until a specific condition is satisfied, the specific condition including a requirement that contact made to the selected area continues to be detected for a predetermined time period from the selection; and executing processing allocated to the selected area when the first judgment unit judges in the negative, and not executing the processing when the first judgment unit judges in the affirmative.

According to the portable communication terminal pertaining to one embodiment of the present invention with the above structure, even when the selecting unit has selected, from among areas on the touchpad on which contact is detected, one area to which processing to be executed has been allocated, the processing allocated to the selected area is not executed when it is judged that the number of areas equals or exceeds a predetermined number within a time period from the selection until the specific condition is satisfied. The specific condition includes the requirement that contact made to the selected area continues to be detected for a predetermined time period from the selection.

When it is judged that the number of areas on which contact is detected equals or exceeds a predetermined number, it can be assumed that contact is made to the touchpad by an object other than the user's finger. Such an assumption holds when a number that is greater than the maximum number of keys which may be simultaneously contacted by one finger of the user is determined as the above predetermined number, for example. When such contact is assumed to be made by the object other than the user's finger after the selection, it can be assumed that the one of the areas has been selected by the object other than the user's finger in the first place.

Accordingly, for example, in the case where a number that is greater than the maximum number of keys which may be simultaneously contacted by one finger of the user is determined as the above predetermined number, the portable communication terminal can reduce the possibility that processing allocated to the selected area is executed by contact made to the touchpad by an object other than the user's finger. This is realized by detecting contact that is assumed to be made to the touchpad by the object other than the user's finger within a time period from the selection until the predetermined time period elapses.

(b) Also, when the first judgment unit judges in the affirmative, the execution control unit may execute display processing corresponding to the selected area.

Accordingly, even when the selecting unit has selected, from among areas on the touchpad on which contact is detected, one area to which processing to be executed has been allocated, the portable communication terminal does not execute the processing allocated to the selected area but performs display processing corresponding to the selected area when it is judged that the number of areas equals or exceeds the predetermined number within a time period from the selection until the above-described specific condition is satisfied.

That is, for example, in the case where a number that is greater than the maximum number of keys which may be simultaneously contacted by one finger of the user is determined as the above predetermined number, the user of the portable communication terminal can be informed of that contact has been made to the touchpad by the object other than his/her finger within a time period from the selection until the specific condition is satisfied.

(c) Also, the portable communication terminal may further comprises: a storage unit configured to store therein a first threshold value used for the selection and a second threshold value that is smaller than the first threshold value, wherein the selecting unit may calculate a value indicating a degree of contact for each of the areas, based on the value output by the touchpad, and selects an area with a value that is equal to or greater than the first threshold value as the one of the areas, and the first judgment unit may judge in the affirmative only when the number of areas with values that are equal to or greater than the second threshold value equals or exceeds the predetermined number.

Accordingly, even when the selecting unit has selected the one area from among the areas, the portable communication terminal does not execute the processing allocated to the selected area when it is judged that the number of areas having values that are smaller than the first threshold value and equal to or greater than the second threshold value changes to a number that is equal to or greater than the predetermined number within a time period from the selection until the specific condition is satisfied.

Accordingly, for example, in the case where a number that is greater than the maximum number of keys which may be simultaneously contacted by one finger of the user is determined as the above predetermined number, the portable communication terminal can reduce the possibility that processing allocated to the selected area is executed by contact made to the touchpad by an object other than the user's finger. This is realized by not only detecting the number of areas having values that are similar to that of the selected area is equal to or greater than the predetermined number but also by detecting the number of areas having values that are smaller than that of the selected area is equal to or greater than the predetermined number within a time period from the selection until the predetermined time period elapses.

(d) Also, the portable communication terminal may further comprises: a second judgment unit configured to judge whether or not, at any point within the time period from the selection until the specific condition is satisfied, the areas include two areas that are not adjacent to each other, values of the two areas being equal to or greater than the second threshold value, wherein the execution control unit may execute the processing allocated to the selected area only when the second judgment unit judges in the negative.

Accordingly, even when the selecting unit has selected the one area from among the areas, the portable communication terminal does not execute the processing when it is judged that there are two areas not adjacent to each other, values of the two areas calculated by the selecting unit being equal to or greater than the second threshold value. Such judgment is made within a time period from the selection until the specific condition is satisfied.

For example, when the size and position of each area is determined so that one finger of the user is not normally in contact with the two areas not adjacent with each other, and when the two areas have values calculated by the selecting unit that are equal to or greater than the second threshold value, it can be assumed that contact is made to the touchpad by an object other than the user's finger. When such contact is assumed to be made by the object other than the user's finger after the selection, it can be assumed that the one of the areas has been selected by the object other than the user's finger in the first place.

Accordingly, for example, when the size and position of each area is determined so that one finger of the user is not normally in contact with the two areas not adjacent with each other, the portable communication terminal can reduce the possibility that processing allocated to the selected area is executed by contact made to the touchpad by an object other than the user's finger. This is realized by detecting contact that is assumed to be made to the touchpad by the object other than the user's finger within a time period from the selection until the predetermined time period elapses.

(e) Also, the specific condition may further include a requirement that the contact detected on the selected area is released.

Accordingly, the portable communication terminal does not execute the processing when it is judged that the number of areas of the touchpad on which contact is detected equals or exceeds the predetermined number, and when it is judged that there are two areas that are not adjacent to each other, values of the two areas calculated by the selecting unit being equal to or greater than the second threshold value. These judgments are made within a time period from when the predetermined time period elapses after the selection until the contact made to the selected area is released.

As described above, it can be assumed that contact is made to the touchpad by an object other than the user's finger in the following two cases: when a number that is greater than the maximum number of keys which may be simultaneously contacted by one finger of the user is determined as the above predetermined number, it is judged that the number of areas on which contact is detected is equal to or greater than the predetermined number; and when the size and position of each area is determined so that one finger of the user is not normally in contact with the two areas not adjacent with each other, it is judged that there are two areas that are not adjacent to each other, values of the two area calculated by the selecting unit being equal to or greater than the second threshold value. When such contact is assumed to be made by the object other than the user's finger within a time period from when the predetermined time period elapses after the selection until the contact made on the selected area is released, it can be assumed that the one of the areas has been selected by the object other than the user's finger in the first place.

Accordingly, for example, in the case where a number that is greater than the maximum number of keys which may be simultaneously contacted by one finger of the user is determined as the above predetermined number, and in the case where the size and position of each area is determined so that one finger of the user is not normally in contact with the two areas not adjacent with each other, the portable communication terminal can reduce the possibility that processing allocated to the selected area is executed by contact made to the touchpad by the object other than the user's finger. This is realized by detecting contact that is assumed to be made to the touchpad by the object other than the user's finger within a time period from when the predetermined time period elapses after the selection until the contact made to the selected area is released.

(f) Also, the processing may be for making a call.

Accordingly, in the case where a number that is greater than the maximum number of keys which may be simultaneously contacted by one finger of the user is determined as the above predetermined number, the portable communication terminal can reduce the possibility that a call corresponding to the selected area is made by contact made to the touchpad by the object other than the user's finger. This is realized by detecting contact that is assumed to be made to the touchpad by the object other than the user's finger within a time period from the selection until the predetermined time period elapses.

(18) The touchpad pertaining to the present invention corresponds to the touchpad 102 pertaining to the exemplary embodiments, the selecting unit, the first judgment unit, the storage unit, and the second judgment unit pertaining to the present invention correspond to the calculation unit 111 and the key determination unit pertaining to the exemplary embodiments, and the execution control unit pertaining to the present invention corresponds to the event notification unit 114 and the application execution unit 120 pertaining to the exemplary embodiments.

(19) The present invention may be a method for use in the above-described portable communication terminal, as well as a computer program for realizing such a method with the use of a computer.

### INDUSTRIAL APPLICABILITY

The portable communication terminal pertaining to the present invention is used by a user when making operations on a touchpad.

### REFERENCE SIGNS LIST

1, 2 housing
3 input key
4 LCD
100 mobile phone
101 sub LCD
102 touchpad
103 time measuring unit
104 storage unit
105 speaker
106 microphone
107 vibrator
108 communication unit
110 control unit
111 calculation unit
112 switching unit
113 key determination unit
114 event notification unit
115 call processing unit
116 audio processing unit
117 display control unit
120 application execution unit

1. A portable communication terminal comprising:
a touchpad configured to detect contact made thereto and output a value indicating a degree of the contact;
a selecting unit configured to select, based on the value output by the touchpad, one area from among areas on the touchpad on which contact is detected, the areas each having processing to be executed allocated thereto;
a first judgment unit configured to judge whether or not the number of areas on the touchpad on which contact is detected equals or exceeds a predetermined number within a time period from the selection until a specific condition is satisfied, the specific condition including a requirement that contact made to the selected area continues to be detected for a predetermined time period from the selection; and
an execution control unit configured, when the first judgment unit judges in the negative, to execute processing allocated to the selected area, and when the first judgment unit judges in the affirmative, not to execute the processing.

2. The portable communication terminal of claim 1, wherein
when the first judgment unit judges in the affirmative, the execution control unit executes display processing corresponding to the selected area.

3. The portable communication terminal of claim 2, further comprising:
a storage unit configured to store therein a first threshold value used for the selection and a second threshold value that is smaller than the first threshold value, wherein
the selecting unit calculates a value indicating a degree of contact for each of the areas, based on the value output by the touchpad, and selects an area with a value that is equal to or greater than the first threshold value as the one of the areas, and
the first judgment unit judges in the affirmative only when the number of areas with values that are equal to or greater than the second threshold value equals or exceeds the predetermined number.

4. The portable communication terminal of claim 3, further comprising:
a second judgment unit configured to judge whether or not, at any point within the time period from the selection until the specific condition is satisfied, the areas include two areas that are not adjacent to each other, values of the two areas being equal to or greater than the second threshold value, wherein
the execution control unit executes the processing allocated to the selected area only when the second judgment unit judges in the negative.

5. The portable communication terminal of claim 4, wherein
the specific condition further includes a requirement that the contact detected on the selected area is released.

6. The portable communication terminal of claim 1, wherein
the processing is for making a call.

7. An input control program used by a portable communication terminal including a touchpad configured to detect contact made thereto and output a value indicating a degree of the contact, the program including the steps of;
selecting, based on the value output by the touchpad, one area from among areas on the touchpad on which contact is detected, the areas each having processing to be executed allocated thereto;
judging whether or not the number of areas on the touchpad on which contact is detected equals or exceeds a predetermined number within a time period from the selection until a specific condition is satisfied, the specific condition including a requirement that contact made to the selected area continues to be detected for a predetermined time period from the selection; and
executing processing allocated to the selected area when the first judgment unit judges in the negative, and not executing the processing when the first judgment unit judges in the affirmative.

8. An input control method used in a portable communication terminal including a touchpad configured to detect contact made thereto and output a value indicating a degree of the contact, the method comprising the steps of:
selecting, based on the value output by the touchpad, one area from among areas on the touchpad on which contact is detected, the areas each having processing to be executed allocated thereto;
judging whether or not the number of areas on the touchpad on which contact is detected equals or exceeds a predetermined number within a time period from the selection until a specific condition is satisfied, the specific condition including a requirement that contact made to the selected area continues to be detected for a predetermined time period from the selection; and
executing processing allocated to the selected area when the first judgment unit judges in the negative, and not executing the processing when the first judgment unit judges in the affirmative.
